(19) United States
(12) Patent Application Publication
(10) Pub. No.: US 2024/0406940 A1
(43) Pub. Date: Dec. 5, 2024

(54) METHOD AND DEVICE IN NODES USED FOR WIRELESS COMMUNICATION

(71) Applicants: Keying WU, Shanghai (CN); Xiaobo ZHANG, Shanghai (CN)

(72) Inventors: Keying WU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/806,735

(22) Filed: Aug. 16, 2024

Related U.S. Application Data
(63) Continuation of application No. PCT/CN2023/075557, filed on Feb. 12, 2023.

(30) Foreign Application Priority Data
Feb. 18, 2022 (CN) 202210153310.1

(51) Int. Cl. H04W 72/0446; H04L 5/00

(52) U.S. Cl. CPC H04W 72/0446; H04L 5/0051

(57) ABSTRACT

A first node receives a first signaling and transmits a first signal. The first signaling indicates scheduling information of the first signal; the first signal comprises a first sub-signal and a second sub-signal; a first field and a second field of the first signaling are respectively used to determine antenna ports for transmitting the first sub-signal and the second sub-signal; a payload of bit(s) in the second field of the first signaling is related to K1 candidate integers; the relationship between the payload of the bit(s) in the second field of the first signaling and the K1 candidate integers is related to whether a time-domain resource occupied by the first sub-signal overlaps with a time-domain resource occupied by the second sub-signal. The above method meets different requirements for the number of bits in the first field and the second field for different multiplexing methods.

### CROSS REFERENCE TO RELATED APPLICATIONS

This application is the continuation of the international patent application No. PCT/CN2023/075557, filed on Feb. 12,2023, and claims the priority benefit of Chinese Patent Application No.202210153310.1, filed on Feb. 18,2022, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

The multi-antenna technique is a crucial part in the 3rd Generation Partner Project (3GPP) Long-term Evolution (LTE) and New Radio (NR) systems. More than one antenna can be configured, at the communication node, e.g., a base station or a User Equipment (UE), to obtain extra degree of freedom in space. Multiple antennas form through beamforming a beam pointing in a specific direction to enhance the communication quality. The degree of freedom provided by a multi-antenna system can be used to enhance the transmission reliability and/or throughput. When the multiple antennas belong to multiple Transmitter Receiver Points (TRPs)/panels, spatial differences between TRPs/panels can be taken advantage of to obtain extra diversity gains. In NR Release 17 (R17), an uplink transmission based on multiple beams/TRPs/panels is supported, which is used for improving the reliability of the uplink transmission. In R17, multi-beam/TRP/panel uplink transmission is achieved by configuring a DCI (i.e., Downlink Control Information) to include two different fields for indicating a Transmitted Precoding Matrix Indicator (TPMI) and/or two different fields for indicating a Sounding reference signal Resource Indicator (SRI).

### SUMMARY

The uplink transmission based on multiple beams/TRPs/panels can be performed by means of time division multiplexing (i.e., occupying time domain resources orthogonal to each other), as provided in R17, or by space division multiplexing or frequency division multiplexing (i.e., occupying overlapped time domain resources). Compared to time-division multiplexing, the implementation of space-division or frequency-division multiplexing is more conducive to improving throughput, especially for users with better channel quality. The applicant has found through research that different multiplexing methods have different requirements for the number of bits in the field(s) used to indicate TPMI and/or SRI. How to design the fields for indicating TPMI and/or SRI to meet the different requirements in different multiplexing methods accordingly is a problem to be solved. How to design the fields for indicating TPMI and/or SRI under space division and/or frequency division multiplexing is another problem to be solved.

To address the above problem, the present application provides a solution. It should be noted that while the above description uses cellular networks, uplink transmissions and multi-beam/TRP/panel as examples, the present application is also applicable to other scenarios such as sidelink transmissions, downlink transmissions and single-beam/TRP/panel and achieves similar technical results as in cellular networks, uplink transmissions and multi-beam/TRP/panel. Additionally, the adoption of a unified solution for various scenarios, including but not limited to those of the cellular network, sidelink, uplink transmission, downlink transmission, multi-beam/TRP/panel, and single-beam/TRP/panel, contributes to the reduction of hardcore complexity and costs. In the case of no conflict, the embodiments of a first node and the characteristics in the embodiments may be applied to a second node, and vice versa. What's more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:

receiving a first signaling, the first signaling indicating scheduling information of a first signal; and

transmitting the first signal;

herein, the first signal comprises a first sub-signal and a second sub-signal; the first signaling comprises a first field and a second field; the first field of the first signaling and the second field of the first signaling are respectively used to determine antenna port(s) for transmitting the first sub-signal and antenna port(s) for transmitting the second sub-signal, or, the first field of the first signaling and the second field of the first signaling are used to determine a precoder for the first sub-signal and a precoder for the second sub-signal, respectively; the first field and the second field each comprise at least one bit, a payload of bit(s) in the second field of the first signaling is related to K1 candidate integers, K1 being a positive integer greater than 1; the K1 candidate integers respectively correspond to K1 numbers of layers; a relationship between the payload of the bit(s) in the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the payload of the bit(s) in the second field of the first signaling is no less than a logarithm of a sum of the K1 candidate integers with base 2; when the time-domain resource occupied by the first sub-signal and the time-domain resource occupied by the second sub-signal are mutually orthogonal, the payload of the bit(s) in the second field of the first signaling is no less than a logarithm of a greatest value of the K1 candidate integers with base 2.

In one embodiment, a problem to be solved in the present application includes: how to design the fields used to indicate TPMI and/or SRI to satisfy the different requirements for the number of bits in different multiplexing methods, respectively. The above method solves this problem by establishing a correlation between the relationship between the number of bits included in the second field of the first signaling and the K1 candidate integers and whether or not the time-domain resource occupied by the first sub-signal and by the second sub-signal are overlapped.

In one embodiment, a problem to be solved in the present application includes: how to design the fields for indicating TPMI and/or SRI in a space division and/or frequency division multiplexing approach. The above method solves this problem by restricting that when the time-domain resource occupied by the first sub-signal and that occupied by the second sub-signal are overlapped, the second field of the first signaling comprises a number of bits that is not less than a logarithm of the sum of the K1 candidate integers with a base of 2.

In one embodiment, characteristics of the above method include that the first field and the second field are each used to indicate a TPMI, or to indicate an SRI, and that the TPMI and/or SRI of the first sub-signal and the TPMI and/or SRI of the second sub-signal are indicated by different fields, i.e., that the first signaling is a multi-beam/TRP/panel-based transmission.

In one embodiment, characteristics of the above method include that the number of bits included in the second field of the first signaling is related to whether or not the time-domain resource occupied by the first sub-signal and that occupied by the second sub-signal are overlapped, i.e., relating to the multiplexing method.

In one embodiment, an advantage of the above method includes that different requirements for the number of bits in the fields used to indicate the TPMI and/or the SRI in different multiplexing modes are satisfied.

In one embodiment, an advantage of the above method includes: addressing the design of the fields used to indicate antenna ports and/or TPMI under space division multiplexing.

In one embodiment, an advantage of the above method includes: ensuring flexibility in indicating the number of layers of the first sub-signal and the second sub-signal under space division and/or frequency division multiplexing.

According to one aspect of the present application, characterized in that the K1 numbers of layers respectively correspond to K1 tables; any of the K1 tables includes multiple rows, and at least one row in any of the K1 tables indicates a TPMI; any of the K1 candidate integers is not less than a number of rows included in the corresponding table.

According to one aspect of the present application, characterized in that the K1 numbers of layers respectively correspond to K1 numbers of combinations, the K1 numbers of combinations being positive integers, respectively; any of the K1 candidate integers is not less than the corresponding number of combinations.

According to one aspect of the present application, characterized in that a payload of bit(s) in the first field of the first signaling is related to K2 candidate integers, K2 being a positive integer greater than 1; the K2 candidate integers respectively correspond to K2 numbers of layers; the payload of the bit(s) in the first field of the first signaling is no less than a logarithm of a sum of the K2 candidate integers with base 2.

According to one aspect of the present application, characterized in that K1 is related to at least one of a first maximum number of layers, a second maximum number of layers, and a third maximum number of layers; the first maximum number of layers, the second maximum number of layers, and the third maximum number of layers are positive integers greater than 1, respectively; and at least one of the first maximum number of layers, the second maximum number of layers, or the third maximum number of layers is configurable.

In one embodiment, characteristics of the above method include: the ability to configure the maximum number of layers corresponding to each beam/TRP/panel, separately.

In one embodiment, characteristics of the above method include: the ability to separately configure the maximum number of layers corresponding to each beam/TRP/panel, and the greatest value of the total number of layers for transmission on different beams/TRPs/panels.

In one embodiment, an advantage of the above method includes: meeting the different needs of each beam/TRP/panel for the maximum number of layers.

According to one aspect of the present application, characterized in that a value of the K1 is related to whether the time-domain resource occupied by the first sub-signal overlaps with the time-domain resource occupied by the second sub-signal.

According to one aspect of the present application, characterized in that K2 is related to at least one of a first maximum number of layers, a second maximum number of layers, and a third maximum number of layers; the first maximum number of layers, the second maximum number of layers, and the third maximum number of layers are positive integers greater than 1, respectively; and at least one of the first maximum number of layers, the second maximum number of layers, or the third maximum number of layers is configurable. According to one aspect of the present application, the first node comprises a UE.

According to one aspect of the present application, the first node comprises a relay node.

The present application provides a method in a second node for wireless communications, comprising:

transmitting a first signaling, the first signaling indicating scheduling information of a first signal; and

receiving the first signal;

herein, the first signal comprises a first sub-signal and a second sub-signal; the first signaling comprises a first field and a second field; the first field of the first signaling and the second field of the first signaling are respectively used to determine antenna port(s) for transmitting the first sub-signal and antenna port(s) for transmitting the second sub-signal, or, the first field of the first signaling and the second field of the first signaling are used to determine a precoder for the first sub-signal and a precoder for the second sub-signal, respectively; the first field and the second field each comprise at least one bit, a payload of bit(s) in the second field of the first signaling is related to K1 candidate integers, K1 being a positive integer greater than 1; the K1 candidate integers respectively correspond to K1 numbers of layers; a relationship between the payload of the bit(s) in the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the payload of the bit(s) in the second field of the first signaling is no less than a logarithm of a sum of the K1 candidate integers with base 2; when the time-domain resource occupied by the first sub-signal and the time-domain resource occupied by the second sub-signal are mutually orthogonal, the payload of the bit(s) in the second field of the first signaling is no less than a logarithm of a greatest value of the K1 candidate integers with base 2.

According to one aspect of the present application, characterized in that the K1 numbers of layers respectively correspond to K1 tables; any of the K1 tables includes multiple rows, and at least one row in any of the K1 tables indicates a TPMI; any of the K1 candidate integers is not less than a number of rows included in the corresponding table.

According to one aspect of the present application, characterized in that the K1 numbers of layers respectively correspond to K1 numbers of combinations, the K1 numbers of combinations being positive integers, respectively; any of the K1 candidate integers is not less than the corresponding number of combinations.

According to one aspect of the present application, characterized in that a payload of bit(s) in the first field of the first signaling is related to K2 candidate integers, K2 being a positive integer greater than 1; the K2 candidate integers respectively correspond to K2 numbers of layers; the payload of the bit(s) in the first field of the first signaling is no less than a logarithm of a sum of the K2 candidate integers with base 2.

According to one aspect of the present application, characterized in that K1 is related to at least one of a first maximum number of layers, a second maximum number of layers, and a third maximum number of layers; the first maximum number of layers, the second maximum number of layers, and the third maximum number of layers are positive integers greater than 1, respectively; and at least one of the first maximum number of layers, the second maximum number of layers, or the third maximum number of layers is configurable.

According to one aspect of the present application, characterized in that a value of the K1 is related to whether the time-domain resource occupied by the first sub-signal overlaps with the time-domain resource occupied by the second sub-signal.

According to one aspect of the present application, characterized in that K2 is related to at least one of a first maximum number of layers, a second maximum number of layers, and a third maximum number of layers; the first maximum number of layers, the second maximum number of layers, and the third maximum number of layers are positive integers greater than 1, respectively; and at least one of the first maximum number of layers, the second maximum number of layers, or the third maximum number of layers is configurable.

According to one aspect of the present application, the second node is a base station.

According to one aspect of the present application, the second node is a UE.

According to one aspect of the present application, the second node is a relay node.

The present application provides a first node for wireless communications, comprising:

a first receiver, receiving a first signaling, the first signaling indicating scheduling information of a first signal; and

a first transmitter, transmitting the first signal;

herein, the first signal comprises a first sub-signal and a second sub-signal; the first signaling comprises a first field and a second field; the first field of the first signaling and the second field of the first signaling are respectively used to determine antenna port(s) for transmitting the first sub-signal and antenna port(s) for transmitting the second sub-signal; the first field of the first signaling and the second field of the first signaling are used to determine a precoder for the first sub-signal and a precoder for the second sub-signal, respectively; the first field and the second field each comprise at least one bit, a payload of bit(s) in the second field of the first signaling is related to K1 candidate integers, K1 being a positive integer greater than 1; the K1 candidate integers respectively correspond to K1 numbers of layers; a relationship between the payload of the bit(s) in the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the payload of the bit(s) in the second field of the first signaling is no less than a logarithm of a sum of the K1 candidate integers with base 2; when the time-domain resource occupied by the first sub-signal and the time-domain resource occupied by the second sub-signal are mutually orthogonal, the payload of the bit(s) in the second field of the first signaling is no less than a logarithm of a greatest value of the K1 candidate integers with base 2.

The present application provides a second node for wireless communications, comprising:

a second transmitter, transmitting a first signaling, the first signaling indicating scheduling information of a first signal; and

a second receiver, receiving the first signal;

herein, the first signal comprises a first sub-signal and a second sub-signal; the first signaling comprises a first field and a second field; the first field of the first signaling and the second field of the first signaling are respectively used to determine antenna port(s) for transmitting the first sub-signal and antenna port(s) for transmitting the second sub-signal; the first field of the first signaling and the second field of the first signaling are used to determine a precoder for the first sub-signal and a precoder for the second sub-signal, respectively; the first field and the second field each comprise at least one bit, a payload of bit(s) in the second field of the first signaling is related to K1 candidate integers, K1 being a positive integer greater than 1; the K1 candidate integers respectively correspond to K1 numbers of layers; a relationship between the payload of the bit(s) in the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the payload of the bit(s) in the second field of the first signaling is no less than a logarithm of a sum of the K1 candidate integers with base 2; when the time-domain resource occupied by the first sub-signal and the time-domain resource occupied by the second sub-signal are mutually orthogonal, the payload of the bit(s) in the second field of the first signaling is no less than a logarithm of a greatest value of the K1 candidate integers with base 2.

In one embodiment, compared with the prior art, the present application is advantageous in the following aspects:

The different needs for the number of bits of the field used to indicate TPMI and/or SRI under different multiplexing methods are met.

The design of the field used to indicate TPMI and/or SRI under space division and/or frequency division multiplexing is addressed.

Under space division and/or frequency division multiplexing, it can dynamically and flexibly indicate the number of layers of signals of different beams/TRPs/panels according to the channel quality of different beams/TRPs/panels, which improves the transmission performance.

It meets the different needs of each beam/TRP/panel for the maximum number of layers.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first signaling and a first signal according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission according to one embodiment of the present application.

FIG. 6 illustrates a schematic diagram of antenna port(s) for transmitting a first sub-signal and antenna port(s) for transmitting a second sub-signal according to one embodiment of the present application.

FIG. 7 illustrates a schematic diagram of a first field of a first signaling and a second field of the first signaling being respectively used to determine antenna port(s) for transmitting a first sub-signal and antenna port(s) for transmitting a second sub-signal according to one embodiment of the present application.

FIG. 8 illustrates a schematic diagram of a first field of a first signaling and a second field of the first signaling being respectively used to determine a precoder for a first sub-signal and a precoder for a second sub-signal according to one embodiment of the present application.

FIG. 9 illustrates a schematic diagram of K1 numbers of layers, K1 tables and K1 candidate integers according to one embodiment of the present application.

FIG. 10 illustrates a schematic diagram of K1 numbers of layers, K1 numbers of combinations and K1 candidate integers according to one embodiment of the present application.

FIG. 11 illustrates a schematic diagram of a payload of bits included in a first field of a first signaling according to one embodiment of the present application.

FIG. 12 illustrates a schematic diagram of K2 numbers of layers, K2 tables and K2 candidate integers according to one embodiment of the present application.

FIG. 13 illustrates a schematic diagram of K2 numbers of layers, K2 numbers of combinations and K2 candidate integers according to one embodiment of the present application.

FIG. 14 illustrates a schematic diagram of relating K1 to at least one of a first maximum number of layers, a second maximum number of layers, or a third maximum number of layers according to one embodiment of the present application.

FIG. 15 illustrates a schematic diagram of relating the value of K1 to whether a time-domain resource occupied by a first sub-signal overlaps with a time-domain resource occupied by a second sub-signal according to one embodiment of the present application.

FIG. 16 illustrates a schematic diagram of relating the value of K1 to whether a time-domain resource occupied by a first sub-signal overlaps with a time-domain resource occupied by a second sub-signal according to one embodiment of the present application.

FIG. 17 illustrates a schematic diagram of relating K2 to at least one of a first maximum number of layers, a second maximum number of layers, or a third maximum number of layers according to one embodiment of the present application.

FIG. 18 illustrates a schematic diagram of relating K2 to a first maximum number of layers and a second maximum number of layers according to one embodiment of the present application.

FIG. 19 illustrates a schematic diagram of relating K2 to a first maximum number of layers and a second maximum number of layers according to one embodiment of the present application.

FIG. 20 illustrates a structure block diagram of a processing device in a first node according to one embodiment of the present application.

FIG. 21 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

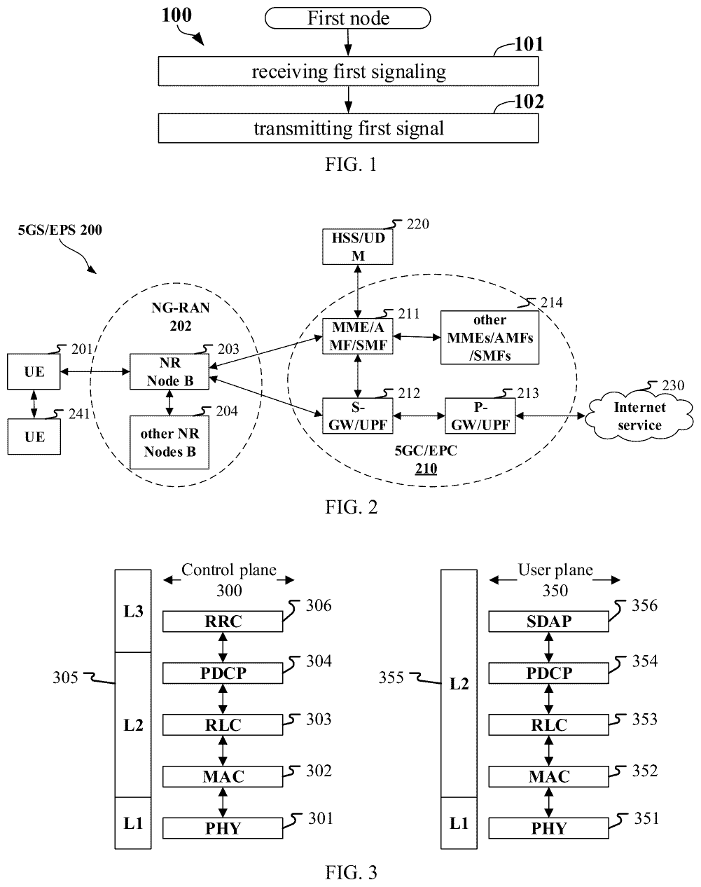

Embodiment 1 illustrates a flowchart of transmission of a first signaling and a first signal according to one embodiment of the present application, as shown in FIG. 1. In 100 illustrated by FIG. 1, each box represents a step. Particularly; the sequential step arrangement in each box herein does not imply a chronological order of steps marked respectively by these boxes.

In Embodiment 1, the first node in the present application receives a first signaling in step 101, the first signaling indicating scheduling information of a first signal; and transmits the first signal in step 102. Herein, the first signal comprises a first sub-signal and a second sub-signal; the first signaling comprises a first field and a second field; the first field of the first signaling and the second field of the first signaling are respectively used to determine antenna port(s) for transmitting the first sub-signal and antenna port(s) for transmitting the second sub-signal; the first field of the first signaling and the second field of the first signaling are used to determine a precoder for the first sub-signal and a precoder for the second sub-signal, respectively; the first field and the second field each comprise at least one bit, a payload of bit(s) in the second field of the first signaling is related to K1 candidate integers, K1 being a positive integer greater than 1; the K1 candidate integers respectively correspond to K1 numbers of layers; a relationship between the payload of the bit(s) in the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the payload of the bit(s) in the second field of the first signaling is no less than a logarithm of a sum of the K1 candidate integers with base 2; when the time-domain resource occupied by the first sub-signal and the time-domain resource occupied by the second sub-signal are mutually orthogonal, the payload of the bit(s) in the second field of the first signaling is no less than a logarithm of a greatest value of the K1 candidate integers with base 2.

In one embodiment, the first signaling comprises a physical-layer signaling.

In one embodiment, the first signaling comprises a dynamic signaling.

In one embodiment, the first signaling comprises a layer 1 (L1) signaling.

Typically, the first signaling comprises Downlink Control Information (DCI).

Typically, the first signaling is a DCI.

In one embodiment, the first signaling comprises UpLink Grant DCI.

In one embodiment, the first signaling comprises DCI used for configured UpLink Grant scheduling activation.

In one embodiment, the first signaling comprises a Radio Resource Control (RRC) signaling.

In one embodiment, the first signaling comprises a Medium Access Control layer Control Element (MAC CE).

In one embodiment, the scheduling information comprises one or more of time-domain resources, frequency-domain resources, a Modulation and Coding Scheme (MCS), a DeModulation Reference Signal (DMRS) port, a Hybrid Automatic Repeat request (HARQ) process number, a Redundancy version (RV), a New data indicator (NDI), a Transmission Configuration Indicator (TCI) state or a Sounding reference signal Resource Indicator (SRI).

In one embodiment, the first signaling explicitly indicates the scheduling information of the first signal.

In one embodiment, the first signaling implicitly indicates the scheduling information of the first signal.

In one embodiment, the first signaling explicitly indicates part of the scheduling information of the first signal, and implicitly indicates the rest of the scheduling information of the first signal.

In one embodiment, the first signaling comprises the scheduling information of the first signal.

In one embodiment, the first signaling indicates a number of layers of the first sub-signal and a number of layers of the second sub-signal.

In one embodiment, the first field of the first signaling is used to determine antenna port(s) for transmitting the first sub-signal, and the second field of the first signaling is used to determine antenna port(s) for transmitting the second sub-signal.

In one embodiment, the first field of the first signaling is used to determine a precoder for the first sub-signal, and the second field of the first signaling is used to determine a precoder for the second sub-signal.

In one embodiment, the first field of the first signaling indicates antenna port(s) for transmitting the first sub-signal, and the second field of the first signaling indicates antenna port(s) for transmitting the second sub-signal.

In one embodiment, the first field of the first signaling indicates a precoder for the first sub-signal, and the second field of the first signaling indicates a precoder for the second sub-signal.

In one embodiment, the first field and the second field each comprise at least one field of a DCI.

In one embodiment, the first field and the second field each comprise all or part of bits in at least one field of a DCI.

In one embodiment, the first field and the second field are each a field of a DCI.

In one embodiment, the first field comprises an SRS resource indicator field in a DCI.

In one embodiment, the first field comprises a field of Precoding information and number of layers in a DCI.

In one embodiment, the first field comprises a first SRS resource indicator field in a DCI.

In one embodiment, the first field comprises a first field of Precoding information and number of layers in a DCI.

In one embodiment, the second field comprises a Second SRS resource indicator field in a DCI.

In one embodiment, the second field comprises a Second Precoding information field in a DCI.

In one embodiment, the second field comprises information in a Second SRS resource indicator field in a DCI.

In one embodiment, the second field comprises information in a Second Precoding information field in a DCI.

In one embodiment, the second field comprises a second SRS resource indicator field in a DCI.

In one embodiment, the second field comprises a second field of Precoding information and number of layers in a DCI.

In one embodiment, the first field and the second field each indicate at least one SRI, or, the first field and the second field each indicate a Transmitted Precoding Matrix Indicator (TPMI).

In one embodiment, the first field indicates at least one SRI and the second field indicates at least one SRI.

In one embodiment, when the first field of the first signaling and the second field of the first signaling are used to determine antenna port(s) for transmitting the first sub-signal and antenna port(s) for transmitting the second sub-signal, respectively, the first field indicates at least one SRI and the second field indicates at least one SRI.

In one embodiment, the first field indicates a TPMI and the second field indicates a TPMI.

In one embodiment, the first field indicates a TPMI and a number of layers, and the second field indicates a TPMI and a number of layers.

In one embodiment, when the first field of the first signaling and the second field of the first signaling are used to determine a precoder for the first sub-signal and a precoder for the second sub-signal, respectively, the first field indicates a TPMI and a number of layers and the second field indicates a TPMI and a number of layers.

In one embodiment, at least one of the first field of the first signaling or the second field of the first signaling further indicates a number of layers of the first sub-signal and a number of layers of the second sub-signal.

In one embodiment, when the time-domain resource occupied by the first sub-signal and the time-domain resource occupied by the second sub-signal are overlapped, the first field of the first signaling indicates a number of layers of the first sub-signal, and the second field of the first signaling indicates a number of layers of the second sub-signal.

In one embodiment, when the time-domain resource occupied by the first sub-signal and the time-domain resource occupied by the second sub-signal are orthogonal to each other, the first field of the first signaling indicates a first number of layers, where a number of layers of the first sub-signal and a number of layers of the second sub-signal are both equal to the first number of layers.

Typically, the first field is located before the second field in the first signaling.

In one embodiment, when a first higher layer parameter is set to “codebook”, the first field of the first signaling is used to determine a precoder for the first sub-signal, and the second field of the first signaling is used to determine a precoder for the second sub-signal; when the first higher layer parameter is set to “nonCodebook”, the first field of the first signaling is used to determine antenna port(s) for transmitting the first sub-signal, and the second field of the first signaling is used to determine antenna port(s) for transmitting the second sub-signal; the first higher layer parameter includes in its name “txConfig”.

In one embodiment, the first higher layer parameter is “txConfig”.

In one embodiment, the first signal comprises a baseband signal.

In one embodiment, the first signal comprises a radio signal.

In one embodiment, the first signal comprises a radio frequency signal.

In one embodiment, the first signal carries at least one Transport Block (TB).

In one embodiment, the first sub-signal carries at least one TB and the second sub-signal carries at least one TB.

In one embodiment, the first sub-signal carries only one TB.

In one embodiment, the second sub-signal carries only one TB.

In one embodiment, the first sub-signal carries multiple TBs.

In one embodiment, the second sub-signal carries multiple TBs.

In one embodiment, the number of TBs carried by the first sub-signal is equal to the number of TBs carried by the second sub-signal.

In one embodiment, whether or not the first sub-signal and the second sub-signal carry the same TB is related to whether or not the time-domain resource occupied by the first sub-signal and the time-domain resource occupied by the second sub-signal are overlapped.

In one embodiment, when the time-domain resource occupied by the first sub-signal and the time-domain resource occupied by the second sub-signal are overlapped, the first sub-signal and the second sub-signal carry different TBs.

In one subembodiment, the first sub-signal carries only one TB, the second sub-signal carries only one TB, and the one TB carried by the first sub-signal is different from that carried by the second sub-signal.

In one embodiment, when the time-domain resource occupied by the first sub-signal and the time-domain resource occupied by the second sub-signal are overlapped, the first sub-signal and the second sub-signal each comprise a different layer of the first signal.

In one embodiment, when the time-domain resource occupied by the first sub-signal and the time-domain resource occupied by the second sub-signal are mutually orthogonal, the first sub-signal and the second sub-signal carry the same TB.

In one subembodiment, the first sub-signal and the second sub-signal carry the same one TB.

In one subembodiment, the first sub-signal and the second sub-signal carry the same multiple TBs.

In one subembodiment, the number of TB(s) carried by the first sub-signal and the second sub-signal is related to the number of layers of the first signal.

In one subembodiment, when the number of layers of the first signal is not greater than 4, the number of TB(s) carried by the first sub-signal and the second sub-signal is equal to 1; when the number of layers of the first signal is greater than 4, the number of TB(s) carried by the first sub-signal and the second sub-signal is equal to 2.

In one embodiment, when the time-domain resource occupied by the first sub-signal and the time-domain resource occupied by the second sub-signal are mutually orthogonal, the first sub-signal and the second sub-signal comprise two repetitions of a same TB.

In one embodiment, when the time-domain resource occupied by the first sub-signal and the time-domain resource occupied by the second sub-signal are overlapped, a number of layers of the first sub-signal and a number of layers of the second sub-signal are indicated separately.

In one embodiment, when the time-domain resource occupied by the first sub-signal and the time-domain resource occupied by the second sub-signal are overlapped, the first signaling indicates a number of layers of the first sub-signal and a number of layers of the second sub-signal separately.

In one embodiment, when the time-domain resource occupied by the first sub-signal and the time-domain resource occupied by the second sub-signal are overlapped, a number of layers of the first signal is equal to a sum of a number of layers of the first sub-signal and a number of layers of the second sub-signal.

In one embodiment, when the time-domain resource occupied by the first sub-signal and the time-domain resource occupied by the second sub-signal are mutually orthogonal, a number of layers of the first sub-signal is equal to a number of layers of the second sub-signal.

In one subembodiment, the number of layers of the first sub-signal is equal to a number of layers of the first signal.

In one embodiment, when the time-domain resource occupied by the first sub-signal and the time-domain resource occupied by the second sub-signal are overlapped, the time-domain resource occupied by the first sub-signal and the time-domain resource occupied by the second sub-signal are fully overlapped.

In one embodiment, when the time-domain resource occupied by the first sub-signal and the time-domain resource occupied by the second sub-signal are overlapped, the time-domain resource occupied by the first sub-signal and the time-domain resource occupied by the second sub-signal are partially overlapped.

In one embodiment, when the time-domain resource occupied by the first sub-signal and the time-domain resource occupied by the second sub-signal are mutually orthogonal, the first signaling indicates a sequential relationship between the first sub-signal and the second sub-signal in time domain.

In one embodiment, when the time-domain resource occupied by the first sub-signal and the time-domain resource occupied by the second sub-signal are mutually orthogonal, a fifth field of the first signaling indicates a sequential relationship between the first sub-signal and the second sub-signal in time domain.

In one subembodiment, the fifth field comprises one field in a DCI.

In one subembodiment, a name of the fifth field includes “SRS resource set”.

In one subembodiment, a name of the fifth field includes “SRS resource set indicator”.

In one embodiment, when the time-domain resource occupied by the first sub-signal and the time-domain resource occupied by the second sub-signal are mutually orthogonal, the first sub-signal is earlier than the second sub-signal in time domain.

In one embodiment, when the time-domain resource occupied by the first sub-signal and the time-domain resource occupied by the second sub-signal are mutually orthogonal, the first sub-signal is later than the second sub-signal in time domain.

In one embodiment, the number of layers means: number of layers.

In one embodiment, the layer means: layer.

In one embodiment, the layer means: MIMO layer.

In one embodiment, for the definition of the layer and the number of layers, refer to 3GPP TS 38.214and 38.211.

Typically, the K1 candidate integers are K1 positive integers, respectively.

In one embodiment, the K1 candidate integers are K1 positive integers greater than 1, respectively.

In one embodiment, the K1 candidate integers are K1 positive integers greater than 1 and no less than 2048, respectively.

Typically, the K1 numbers of layers are K1 positive integers, respectively.

Typically, the K1 numbers of layers are equal to 1, 2, . . . K1, respectively.

Typically, the K1 numbers of layers are mutually unequal.

In one embodiment, the K1 numbers of layers are positive integers not greater than 4, respectively.

In one embodiment, the K1 numbers of layers are positive integers not greater than 8, respectively.

In one embodiment, K1 is a positive integer greater than 1 and no greater than 4.

In one embodiment, K1 is a positive integer greater than 1 and no greater than 8.

In one embodiment, there is one number of layers being greater than K1 among the K1 numbers of layers.

In one embodiment, the K1 candidate integers are respectively related to the K1 numbers of layers.

In one embodiment, the K1 numbers of layers are respectively used to determine the K1 candidate integers.

In one embodiment, the payload refers to: payload.

Typically; the phrase a payload of bits refers to: a number of bits.

Typically, the phrase a payload of bits refers to: a bitwidth.

Typically, the phrase a payload of bit(s) in the second field refers to: a number of bit(s) included in the second field.

Typically, the phrase a payload of bit(s) in the second field refers to: a bitwidth of the second field.

In one embodiment, when the time-domain resource occupied by the first sub-signal and the time-domain resource occupied by the second sub-signal are overlapped, the logarithm of the sum of the K1 candidate integers with a base of 2 is used to determine the payload of bit(s) in the second field of the first signaling; when the time-domain resource occupied by the first sub-signal and the time-domain resource occupied by the second sub-signal are mutually orthogonal, the logarithm of a greatest value of the K1 candidate integers with a base of 2 is used to determine the payload of bit(s) in the second field of the first signaling.

Typically, when the time-domain resource occupied by the first sub-signal and the time-domain resource occupied by the second sub-signal are overlapped, the payload of bit(s) in the second field of the first signaling is equal to a smallest positive integer that is not less than the logarithm of the sum of the K1 candidate integers with a base of 2; and when the time-domain resource occupied by the first sub-signal and the time-domain resource occupied by the second sub-signal are mutually orthogonal, the payload of bit(s) in the second field of the first signaling is equal to a smallest positive integer that is not less than the logarithm of a greatest value of the K1 candidate integers with a base of 2.

Typically, when the time-domain resource occupied by the first sub-signal and the time-domain resource occupied by the second sub-signal are overlapped, the payload of bit(s) in the second field of the first signaling is equal to a nearest integer obtained by rounding up the logarithm of the sum of the K1 candidate integers with a base of 2; and when the time-domain resource occupied by the first sub-signal and the time-domain resource occupied by the second sub-signal are mutually orthogonal, the payload of bit(s) in the second field of the first signaling is equal to a nearest integer obtained by rounding up the logarithm of a greatest value of the K1 candidate integers with a base of 2.

In one embodiment, when the time-domain resource occupied by the first sub-signal and the time-domain resource occupied by the second sub-signal are overlapped, the payload of bit(s) in the second field of the first signaling is equal to the logarithm of the sum of the K1 candidate integers with a base of 2 being rounded up to a nearest integer plus a first bit number; and when the time-domain resource occupied by the first sub-signal and the time-domain resource occupied by the second sub-signal are mutually orthogonal, the payload of bit(s) in the second field of the first signaling is equal to the logarithm of a greatest value of the K1 candidate integers with a base of 2 being rounded up to a nearest integer plus a second bit number; the first bit number and the second bit number are non-negative integers, respectively, and at least one of the first bit number or the second bit number is greater than 0.

In one subembodiment, the first bit number is not to be configured.

In one subembodiment, the second bit number is not to be configured.

In one subembodiment, the first bit number is configurable.

In one subembodiment, the second bit number is configurable.

In one subembodiment, the first bit number is equal to 0, and the second bit number is greater than 0.

In one subembodiment, the first bit number and the second bit number are both greater than 0.

In one embodiment, the phrase that the time-domain resource occupied by the first sub-signal and the time-domain resource occupied by the second sub-signal are overlapped includes that the time-frequency resource occupied by the first sub-signal and the time-frequency resource occupied by the second sub-signal are overlapped.

In one embodiment, the phrase that the time-domain resource occupied by the first sub-signal and the time-domain resource occupied by the second sub-signal are overlapped includes that the first sub-signal and the second sub-signal occupy overlapped time-domain resources and mutually orthogonal frequency-domain resources.

In one embodiment, the phrase when the time-domain resource occupied by the first sub-signal and the time-domain resource occupied by the second sub-signal are overlapped includes: when the time-frequency resource occupied by the first sub-signal and the time-frequency resource occupied by the second sub-signal are overlapped.

In one embodiment, the phrase when the time-domain resource occupied by the first sub-signal and the time-domain resource occupied by the second sub-signal are overlapped includes: when the first sub-signal and the second sub-signal occupy overlapped time-domain resources and mutually orthogonal frequency-domain resources.

In one embodiment, the phrase when the time-domain resource occupied by the first sub-signal and the time-domain resource occupied by the second sub-signal are overlapped means: when the time-frequency resource occupied by the first sub-signal and the time-frequency resource occupied by the second sub-signal are overlapped.

In one embodiment, the phrase when the time-domain resource occupied by the first sub-signal and the time-domain resource occupied by the second sub-signal are overlapped only means: when the time-frequency resource occupied by the first sub-signal and the time-frequency resource occupied by the second sub-signal are overlapped.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The network architecture 200 of the LTE, LTE-A and future 5G systems may be called an Evolved Packet System (EPS) 200. The 5G NR or LTE network architecture 200 may be called a 5G System/Evolved Packet System (5GS/EPS) 200 or other suitable terminology. The 5GS/EPS 200 may comprise one or more UEs 201, a UE 241 in sidelink communication with the UE(s) 201, an NG-RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 includes NR (New Radio) Node B (gNB) 203 and other gNB 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface.

The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching (PS) services.

In one embodiment, the first node in the present application includes the UE 201.

In one embodiment, the second node in the present application includes the gNB 203.

In one embodiment, a radio link between the UE 201 and the gNB 203 is a cellular link.

In one embodiment, a transmitter of the first signaling includes the gNB 203.

In one embodiment, a receiver of the first signaling includes the UE 201.

In one embodiment, a transmitter of the first signal includes the UE 201.

In one embodiment, a receiver of the first signal includes the gNB 203.

In one embodiment, the UE 201 supports simultaneous multi-panel/TRP UL transmission.

### Embodiment 3

Embodiment 3 illustrates a schematic diagram of an example of a radio protocol architecture of a user plane and a control plane according to the present application, as shown in FIG. 3.

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node as well as between two UEs. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling is generated by the PHY 301, or the PHY 351.

In one embodiment, the first signaling is generated by the MAC sublayer 302 or the MAC sublayer 352.

In one embodiment, the first signaling is generated by the RRC sublayer 306.

In one embodiment, the first signal is generated by the PHY 301, or the PHY 351.

In one embodiment, the higher layer in the present application refers to a layer above the PHY layer.

### Embodiment 4

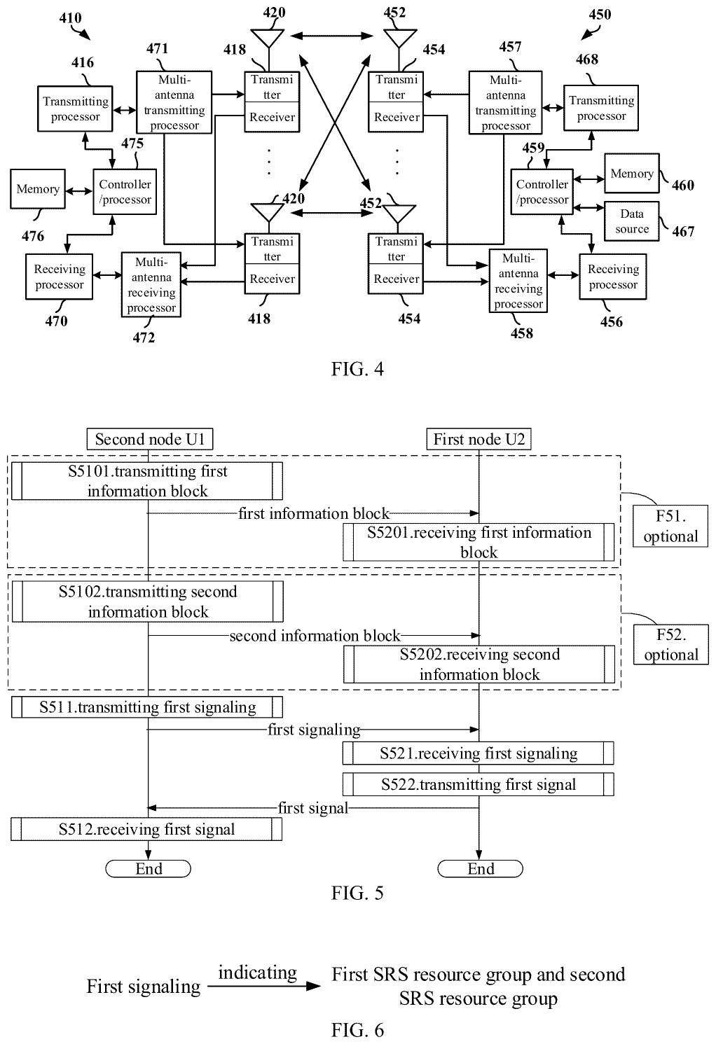

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the constellation mapping corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream into a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450—targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2 layer. Or various control signals can be provided to the L3 for processing. The controller/processor 459 is also in charge of using ACK and/or NACK protocols for error detection as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 layer functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives the first signaling; and transmits the first signal.

In one embodiment, the second communication device 450 comprises a memory that stores a computer readable instruction program. The computer readable instruction program generates actions when executed by at least one processor. The actions include: receiving the first signaling; and transmitting the first signal.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits the first signaling; and receives the first signal.

In one embodiment, the first communication device 410 comprises a memory that stores a computer readable instruction program. The computer readable instruction program generates actions when executed by at least one processor. The actions include: transmitting the first signaling; and receiving the first signal.

In one embodiment, the first node in the present application comprises the second communication device 450.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460 or the data source 467 is used to receive the first signaling; at least one of the antenna 420, the transmitter 418, the transmitting processor 416, the multi-antenna transmitting processor 471, the controller/processor 475 or the memory 476 is used to transmit the first signaling.

In one embodiment, at least one of the antenna 420, the receiver 418, the receiving processor 470, the multi-antenna receiving processor 472, the controller/processor 475 or the memory 476 is used to receive the first signal; at least one of the antenna 452, the transmitter 454, the transmitting processor 468, the multi-antenna transmitting processor 457, the controller/processor 459, the memory 460 or the data source 467 is used to transmit the first signal.

### Embodiment 5

Embodiment 5 illustrates a flowchart of transmission according to one embodiment of the present application; as shown in FIG. 5. In FIG. 5, a second node U1 and a first node U2 are communication nodes that transmit via an air interface. In FIG. 5, steps marked by the box F51 and the box F52 are optional, respectively.

The second node U1 transmits a first information block in step S5101; transmits a second information block in step S5102; transmits a first signaling in step S511; and receives a first signal in step S512.

The first node U2 receives a first information block in step S5201; receives a second information block in step S5202; receives a first signaling in step S521; and transmits a first signal in step S522.

In Embodiment 5, the first signal comprises a first sub-signal and a second sub-signal; the first signaling comprises a first field and a second field; the first field of the first signaling and the second field of the first signaling are respectively used by the first node U2 to determine antenna port(s) for transmitting the first sub-signal and antenna port(s) for transmitting the second sub-signal, or, the first field of the first signaling and the second field of the first signaling are used by the first node U2 to determine a precoder for the first sub-signal and a precoder for the second sub-signal, respectively; the first field and the second field each comprise at least one bit, a payload of bit(s) in the second field of the first signaling is related to K1 candidate integers, K1 being a positive integer greater than 1; the K1 candidate integers respectively correspond to K1 numbers of layers; a relationship between the payload of the bit(s) in the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the payload of the bit(s) in the second field of the first signaling is no less than a logarithm of a sum of the K1 candidate integers with base 2; when the time-domain resource occupied by the first sub-signal and the time-domain resource occupied by the second sub-signal are mutually orthogonal, the payload of the bit(s) in the second field of the first signaling is no less than a logarithm of a greatest value of the K1 candidate integers with base 2.

In one embodiment, the first node U2 is the first node in the present application.

In one embodiment, the second node U1 is the second node in the present application.

In one embodiment, an air interface between the second node U1 and the first node U2 includes a wireless interface between a base station and a UE.

In one embodiment, an air interface between the second node U1 and the first node U2 includes a radio interface between a relay node and a UE.

In one embodiment, an air interface between the second node U1 and the first node U2 includes a radio interface between a UE and another UE.

In one embodiment, the second node U1 is a maintenance base station for a serving cell of the first node U2.

In one embodiment, the first signaling is transmitted in a downlink physical layer data channel (i.e., a downlink channel capable of bearing physical layer data).

In one embodiment, the first signaling is transmitted in a Physical Downlink Shared Channel (PDSCH).

In one embodiment, the first signaling is transmitted in a downlink physical layer control channel (i.e., a downlink channel only capable of bearing physical layer signaling).

In one embodiment, the first signaling is transmitted in a Physical Downlink Control Channel (PDCCH).

In one embodiment, the first signal is transmitted in an uplink physical layer data channel (i.e., an uplink channel capable of bearing physical layer data).

In one embodiment, the first signal is transmitted in a Physical Uplink Shared Channel (PUSCH).

In one embodiment, the steps in box F51 in FIG. 5 of the accompanying drawings exist, where the method in a first node for wireless communications comprises: receiving a first information block; and the method in a second node for wireless communications comprises: transmitting the first information block; where the first information block is used to configure at least one of the first maximum number of layers, the second maximum number of layers or the third maximum number of layers.

In one embodiment, the first information block is used to configure only the first maximum number of layers of the first maximum number of layers, the second maximum number of layers and the third maximum number of layers.

In one embodiment, the first information block is used to configure only the first maximum number of layers and the second maximum number of layers of the first maximum number of layers, the second maximum number of layers and the third maximum number of layers.

In one embodiment, the first information block is used to configure only the first maximum number of layers and the third maximum number of layers of the first maximum number of layers, the second maximum number of layers and the third maximum number of layers.

In one embodiment, the first information block is used to configure the first maximum number of layers, the second maximum number of layers and the third maximum number of layers.

In one embodiment, the first information block is carried by a higher layer signaling.

In one embodiment, the first information block comprises all or partial information in one or more Information Elements (IEs).

In one embodiment, the first information block is transmitted on a PDSCH.

In one embodiment, the steps in box F52 in FIG. 5 of the accompanying drawings exist, where the method in a first node for wireless communications comprises: receiving a second information block; and the method in a second node for wireless communications comprises: transmitting the second information block; where whether a time-domain resource occupied by the first sub-signal overlaps with a time-domain resource occupied by the second sub-signal is related to the second information block.

In one embodiment, the second information block is carried by a higher layer signaling.

In one embodiment, the second information block comprises all or partial information in one IE.

In one embodiment, the second information block comprises all or partial information in a first IE, the first IE including “PUSCH-Config” in its name.

In one embodiment, the second information block comprises information in a sixth field in a first IE as shown, the sixth field including “maxNrofCodeWords” in its name.

In one embodiment, the second information block is used to determine whether uplink two-codeword transmission is enabled.

In one embodiment, the second information block is used to determine whether two-codeword transmissions respectively based on different SRS resource sets are enabled in the same time-domain resource.

In one embodiment, when two-codeword transmissions based on different SRS resource sets in the same time-domain resource are not enabled, the time-domain resource occupied by the first sub-signal and the time-domain resource occupied by the second sub-signal are mutually orthogonal.

In one embodiment, the second information block is transmitted on a PDSCH.

### Embodiment 6

Embodiment 6 illustrates a schematic diagram of antenna port(s) for transmitting a first sub-signal and antenna port(s) for transmitting a second sub-signal according to one embodiment of the present application; as shown in FIG. 6. In Embodiment 6, the first signaling indicates a first Sounding Reference Signal (SRS) resource group and a second SRS resource group, the first SRS resource group and the second SRS resource group each comprising at least one SRS resource; the first SRS resource group comprising at least one SRS resource in a first SRS resource set, the second SRS resource group comprising at least one SRS resource in a second SRS resource set, the first SRS resource set and the second SRS resource set each comprising at least one SRS resource, any SRS resource in the first SRS resource set comprises at least one SRS port, and any SRS resource in the second SRS resource set comprises at least one SRS port; the first sub-signal is transmitted by the same antenna port as the SRS port in the first SRS resource group, and the second sub-signal is transmitted by the same SRS port as the SRS port in the second SRS resource group; the number of SRS resources included in the first SRS resource set is equal to a first resource number, while the number of SRS resources included in the second SRS resource set is equal to a second resource number.

In one embodiment, the number of antenna port(s) for transmitting the first sub-signal is equal to 1.

In one embodiment, the number of antenna port(s) for transmitting the first sub-signal is greater than 1.

In one embodiment, the number of antenna port(s) for transmitting the second sub-signal is equal to 1.

In one embodiment, the number of antenna port(s) for transmitting the second sub-signal is greater than 1.

Typically, a higher-layer parameter “usage” associated with the first SRS resource set and a higher-layer parameter “usage” associated with the second SRS resource set are both configured as “codebook” or “nonCodebook”.

Typically, the first SRS resource set is identified by an SRS-ResourceSetId, while the second SRS resource set is identified by an SRS-ResourceSetId; the SRS-ResourceSetId of the first SRS resource set is not equal to the SRS-ResourceSetId of the second SRS resource set.

Typically, an SRS-ResourceSetId of the first SRS resource set is less than an SRS-ResourceSetId of the second SRS resource set.

Typically, the first SRS resource set and the second SRS resource set are respectively configured by a second higher layer parameter, where the name of the second higher layer parameter includes “srs-ResourceSet”.

In one subembodiment, the name of the second higher layer parameter includes “srs-ResourceSetToAddModList”.

In one exemplary subembodiment of the above embodiment, the second higher layer parameter configures two SRS resource sets, the higher layer parameters “usage” associated with the two SRS resource sets are both set to “codebook” or “nonCodebook”; the first SRS resource set is the SRS resource set corresponding to the smaller SRS-ResourceSetId between the two SRS resource sets, and the second SRS resource set is the SRS resource set corresponding to the larger SRS-ResourceSetId between the two SRS resource sets.

In one subembodiment, the second higher layer parameter configures two SRS resource sets, the higher layer parameters “usage” associated with the two SRS resource sets are both set to “codebook” or “nonCodebook”; the first SRS resource set is a first SRS resource set of the two SRS resource sets, and the second SRS resource set is a second SRS resource set of the two SRS resource sets.

Typically, any SRS resource in the first SRS resource set is identified by an SRS-ResourceId and any SRS resource in the second SRS resource set is identified by an SRS-ResourceId.

In one embodiment, any two SRS resources in the first SRS resource set have equal numbers of SRS ports.

In one embodiment, there are two SRS resources in the first SRS resource set having unequal numbers of SRS ports.

In one embodiment, any two SRS resources in the second SRS resource set have equal numbers of SRS ports.

In one embodiment, there are two SRS resources in the second SRS resource set having unequal numbers of SRS ports.

In one embodiment, a number of SRS ports of any SRS resource in the first SRS resource set is equal to a number of SRS ports of any SRS resource in the second SRS resource set.

In one embodiment, there is one SRS resource in the first SRS resource set having an unequal number of SRS ports compared with those of an SRS resource in the second SRS resource set.

In one embodiment, a number of SRS ports of any SRS resource in the first SRS resource set is unequal to a number of SRS ports of any SRS resource in the second SRS resource set.

In one embodiment, the definition of the SRS-ResourceSetId can be found in 3GPP TS38.331.

In one embodiment, the definition of the SRS-ResourceId can be found in 3GPP TS38.331.

In one embodiment, any SRS resource in the first SRS resource group belongs to the first SRS resource set, and any SRS resource in the second SRS resource group belongs to the second SRS resource set.

### Embodiment 7

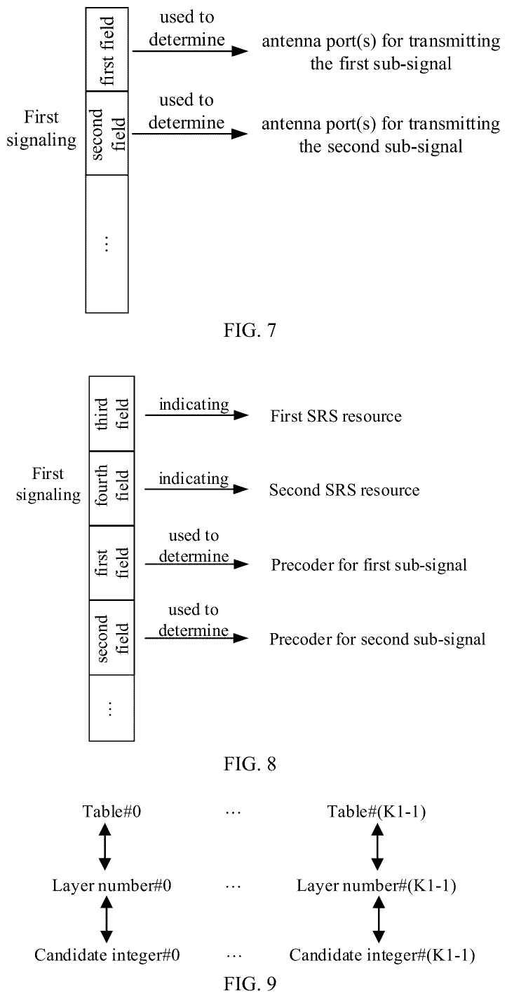

Embodiment 7 illustrates a schematic diagram of a first field of a first signaling and a second field of the first signaling being respectively used to determine antenna port(s) for transmitting a first sub-signal and antenna port(s) for transmitting a second sub-signal according to one embodiment of the present application; as shown in FIG. 7. In Embodiment 7, the first field of the first signaling and the second field of the first signaling are used to determine antenna port(s) for transmitting the first sub-signal and antenna port(s) for transmitting the second sub-signal, respectively; the first field of the first signaling indicating the first SRS resource group in Embodiment 6, and the second field of the first signaling indicating the second SRS resource group in Embodiment 6; the first SRS resource group comprises L1 SRS resource(s), and the second SRS resource group comprises L2 SRS resource(s), L1 and L2 being positive integers, respectively.

In one embodiment, the first SRS resource group comprises only one SRS resource.

In one embodiment, the second SRS resource group comprises only one SRS resource.

In one embodiment, the first SRS resource group comprises multiple SRS resources.

In one embodiment, the second SRS resource group comprises multiple SRS resources.

In one embodiment, any SRS resource in the first SRS resource group includes only one SRS port, and any SRS resource in the second SRS resource group includes only one SRS port.

In one embodiment, a number of layers of the first sub-signal is equal to the number of SRS resources included in the first SRS resource group, and a number of layers of the second sub-signal is equal to the number of SRS resources included in the second SRS resource group.

In one embodiment, the first sub-signal comprises L1 layers and the second sub-signal comprises L2 layers; the L1 layers are transmitted by the same antenna ports as the SRS ports of the L1 SRS resources, respectively, and the L2 layers are transmitted by the same antenna ports as the SRS ports of the L2 SRS resources, respectively.

In one embodiment, the first sub-signal comprises L1 layers and the second sub-signal comprises L2 layers; the L1 layers are mapped to the same antenna ports as the SRS ports of the L1 SRS resources, respectively, and the L2 layers are mapped to the same antenna ports as the SRS ports of the L2 SRS resources, respectively.

In one embodiment, the first sub-signal comprises L1 layers and the second sub-signal comprises L2 layers; the L1 layers, upon being precoded by identity matrices, are mapped to the same antenna ports as the SRS ports of the L1 SRS resources, respectively, and the L2 layers, upon being precoded by identity matrices, are mapped to the same antenna ports as the SRS ports of the L2 SRS resources, respectively.

### Embodiment 8

Embodiment 8 illustrates a schematic diagram of a first field of a first signaling and a second field of the first signaling being respectively used to determine a precoder for a first sub-signal and a precoder for a second sub-signal according to one embodiment of the present application; as shown in FIG. 8. In Embodiment 8, the first field of the first signaling and the second field of the first signaling are used to determine a precoder for the first sub-signal and a precoder for the second sub-signal, respectively, the first signaling comprises a third field and a fourth field, the third field of the first signaling indicating a first SRS resource and the fourth field of the first signaling indicating a second SRS resource; the first SRS resource is an SRS resource in the first SRS resource set in Embodiment 6, and the second SRS resource is an SRS resource in the second SRS resource set in Embodiment 6; the third field and the fourth field each comprise at least one bit.

In one embodiment, when the first field of the first signaling and the second field of the first signaling are used to determine a precoder for the first sub-signal and a precoder for the second sub-signal, respectively, the first SRS resource group in Embodiment 6 comprises only the first SRS resource and the second SRS resource group in Embodiment 6 comprises only the second SRS resource.

In one embodiment, the first SRS resource comprises multiple SRS ports; the second SRS resource comprises multiple SRS ports.

In one embodiment, the third field indicates an SRI and the fourth field indicates an SRI.

In one embodiment, the third field and the fourth field each comprise at least one field of a DCI.

In one embodiment, the first field comprises a field of Precoding information and number of layers in a DCI, and the third field comprises an SRS resource indicator field in a DCI.

In one embodiment, the first field comprises a first field of Precoding information and number of layers in a DCI, and the third field comprises a first SRS resource indicator field in a DCI.

In one embodiment, the second field comprises a Second Precoding information field in a DCI, and the fourth field comprises a Second SRS resource indicator field in a DCI.

In one embodiment, the second field comprises a second field of Precoding information and number of layers in a DCI, and the fourth field comprises a second SRS resource indicator field in a DCI.

In one embodiment, the third field is located before the fourth field in the first signaling.

In one embodiment, the first field of the first signaling indicates a first precoder, and the second field of the first signaling indicates a second precoder; the first sub-signal comprises L1 layers, and the second sub-signal comprises L2 layers, L1 and L2 being positive integers, respectively; the L1 layers, after being precoded by the first precoder, are mapped to the same antenna port as the SRS port of the first SRS resource, while the L2 layers, after being precoded by the second precoder, are mapped to the same antenna port as the SRS port of the second SRS resource.

In one subembodiment, the first precoder is a matrix or a column vector, and the second precoder is a matrix or a column vector; a number of rows of the first precoder is equal to a number of SRS ports of the first SRS resource, and a number of columns of the first precoder is equal to L1; a number of rows of the second precoder is equal to a number of SRS ports of the second SRS resource, and a number of columns of the second precoder is equal to L2.

### Embodiment 9

Embodiment 9 illustrates a schematic diagram of K1 numbers of layers, K1 tables and K1 candidate integers according to one embodiment of the present application; as shown in FIG. 9. In Embodiment 9, the K1 numbers of layers respectively correspond to K1 tables; at least one row in any of the K1 tables indicates a TPMI; any of the K1 candidate integers is not less than a number of rows included in the corresponding table. In FIG. 9, the K1 numbers of layers are denoted as layer number #0, . . . , layer number (K1-1), and the K1 tables are denoted as table #0, . . . , table (K1-1), and the K1 candidate integers are denoted as candidate integer #0, candidate integer (K1-1).

In one embodiment, the K1 candidate integers respectively correspond to the K1 tables, and the table corresponding to any one of the K1 candidate integers is: the table corresponding to the number of layers corresponding to the any one of the candidate integers.

In one embodiment, the TPMI means: Transmitted Precoding Matrix Indicator.

Typically, when a first higher layer parameter is set to “codebook”, the K1 numbers of layers respectively correspond to the K1 tables, and any of the K1 candidate integers is not less than a number of rows included in the corresponding table; the first higher layer parameter includes in its name “txConfig”.

In one embodiment, any of the K1 candidate integers is not less than the number of rows included in the corresponding table.

Typically, the K1 candidate integers are equal to the numbers of rows included in the K1 tables respectively.

In one embodiment, any of the K1 candidate integers is equal to the number of rows included in the corresponding table.

In one embodiment, the K1 candidate integers respectively correspond to K1 coefficients, and any of the K1 candidate integers is equal to the sum of a number of rows included in a corresponding table and a corresponding coefficient; the K1 coefficients are non-negative integers, respectively, and at least one of the K1 coefficients is a positive integer.

In one subembodiment, the K1 coefficients are all positive integers.

In one subembodiment, there is one coefficient being equal to 0 among the K1 coefficients.

In one subembodiment, the K1 coefficients are not to be configured.

In one subembodiment, the K1 coefficients are configurable.

In one embodiment, any row in any one of the K1 tables indicates a TPMI or is reserved.

In one embodiment, any row in any given table of the K1 tables indicates a TPMI or is reserved to a given number of layers; the given number of layers is a number of layers corresponding to the any given table among the K1 numbers of layers.

In one embodiment, any row in any given table of the K1 tables indicates a TPMI and a number of layers or is reserved; the number of layers is equal to a number of layers corresponding to the any given table among the K1 numbers of layers.

In one embodiment, any row in any given table of the K1 tables indicates a TPMI and a number of layers, or is reserved for a given number of layers; the number of layers is equal to the given number of layers, the given number of layers being a number of layers corresponding to the any given table among the K1 numbers of layers.

In one embodiment, any row in any one of the K1 tables indicates a TPMI.

In one embodiment, any row in any one of the K1 tables indicates a TPMI and a number of layers.

In one subembodiment, the any row indicates that the number of layers is equal to a number of layers corresponding to the any table among the K1 numbers of layers.

In one subembodiment, the any row indicates that a number of rows of a corresponding precoder for the TPMI is equal to a number of SRS ports of the second SRS resource of Embodiment 8.

In one embodiment, a value of “codebookSubset” corresponding to any given table of the K1 tables is equal to a third higher layer parameter value.

In one embodiment, if any row in any of the K1 tables indicates a TPMI and a number of layers, the any row indicates only a TPMI and a number of layers.

In one embodiment, any of the K1 tables comprises one or more rows of only a portion of a Table of Table 7.3.1.1.2-2, Table 7.3.1.1.2-2A, Table 7.3.1.1.2-2B, Table 7.3.1.1.2-2C, Table 7.3.1.1.2-2D, of 3GPP TS38.212. Table 7.3.1.1.2-2E, Table 7.3.1.1.2-3, Table 7.3.1.1.2-3A, Table 7.3.1.1.2-4, Table 7.3.1.1.2-4A, Table 7.3.1.1.2-4B, Table 7.3.1.1.2-4C, Table 7.3.1.1.2-5, or Table 7.3.1.1.2-5A, that corresponds to “codebookSubset” being equal to a third higher layer parameter value.

In one embodiment, the K1 tables respectively comprise different rows of a portion of a same Table of Table 7.3.1.1.2-2, Table 7.3.1.1.2-2A, Table 7.3.1.1.2-2B, Table 7.3.1.1.2-2C, Table 7.3.1.1.2-2D, of 3GPP TS38.212. Table 7.3.1.1.2-2E, Table 7.3.1.1.2-3, Table 7.3.1.1.2-3A, Table 7.3.1.1.2-4, Table 7.3.1.1.2-4A, Table 7.3.1.1.2-4B, Table 7.3.1.1.2-4C, Table 7.3.1.1.2-5, or Table 7.3.1.1.2-5A, that corresponds to “codebookSubset” being equal to a third higher layer parameter value.

In one embodiment, the K1 tables respectively comprise rows corresponding to the K1 numbers of layers of a portion of a same Table of Table 7.3.1.1.2-2, Table 7.3.1.1.2-2A, Table 7.3.1.1.2-2B, Table 7.3.1.1.2-2C, Table 7.3.1.1.2-2D, of 3GPP TS38.212. Table 7.3.1.1.2-2E, Table 7.3.1.1.2-3, Table 7.3.1.1.2-3A, Table 7.3.1.1.2-4, Table 7.3.1.1.2-4A, Table 7.3.1.1.2-4B, Table 7.3.1.1.2-4C, Table 7.3.1.1.2-5, or Table 7.3.1.1.2-5A, that corresponds to “codebookSubset” being equal to a third higher layer parameter value.

In one embodiment, a given table is any of the K1 tables, the given table corresponding to a given number of layers of the K1 numbers of layers; the given table comprises all rows corresponding to the given number of layers of a portion of a Table of Table 7.3.1.1.2-2, Table 7.3.1.1.2-2A, Table 7.3.1.1.2-2B, Table 7.3.1.1.2-2C, Table 7.3.1.1.2-2D, of 3GPP TS38.212. Table 7.3.1.1.2-2E, Table 7.3.1.1.2-3, Table 7.3.1.1.2-3A, Table 7.3.1.1.2-4, Table 7.3.1.1.2-4A, Table 7.3.1.1.2-4B, Table 7.3.1.1.2-4C, Table 7.3.1.1.2-5, or Table 7.3.1.1.2-5A, that corresponds to “codebookSubset” being equal to a third higher layer parameter value.

In one embodiment, a given table is one of the K1 tables, the given table corresponding to a given number of layers of the K1 numbers of layers; the given table comprises only part of rows corresponding to the given number of layers of a portion of a same Table of Table 7.3.1.1.2-2, Table 7.3.1.1.2-2A, Table 7.3.1.1.2-2B, Table 7.3.1.1.2-2C, Table 7.3.1.1.2-2D, of 3GPP TS38.212. Table 7.3.1.1.2-2E, Table 7.3.1.1.2-3, Table 7.3.1.1.2-3A, Table 7.3.1.1.2-4, Table 7.3.1.1.2-4A, Table 7.3.1.1.2-4B, Table 7.3.1.1.2-4C, Table 7.3.1.1.2-5, or Table 7.3.1.1.2-5A, that corresponds to “codebookSubset” being equal to a third higher layer parameter value.

In one embodiment, the third higher layer parameter value is the value of a higher layer parameter “codebookSubset” that the first node is configured with.

In one embodiment, the third higher layer parameter value is the value of a higher layer parameter “codebookSubset” that the first node is configured with and that corresponds to the second SRS resource set in Embodiment 6.

In one embodiment, the third higher layer parameter value is equal to one of “fully AndPartialAndNonCoherent”, “partialAndNonCoherent” or “nonCoherent”.

In one embodiment, the second field of the first signaling indicates a precoder for the second sub-signal from the K1 tables.

In one embodiment, the second field of the first signaling indicates from the K1 tables a precoder for the second sub-signal and a number of layers of the second sub-signal.

In one embodiment, the second field of the first signaling indicates a precoder for the second sub-signal from one of the K1 tables.

Typically, when the time-domain resource occupied by the first sub-signal and the time-domain resource occupied by the second sub-signal are overlapped, the second field of the first signaling indicates from the K1 tables a precoder for the second sub-signal and a number of layers of the second sub-signal.

Typically, when the time-domain resource occupied by the first sub-signal and the time-domain resource occupied by the second sub-signal are orthogonal to each other, the second field of the first signaling indicates a precoder for the second sub-signal from one of the K1 tables whose corresponding number of layers is equal to the number of layers of the first sub-signal.

### Embodiment 10

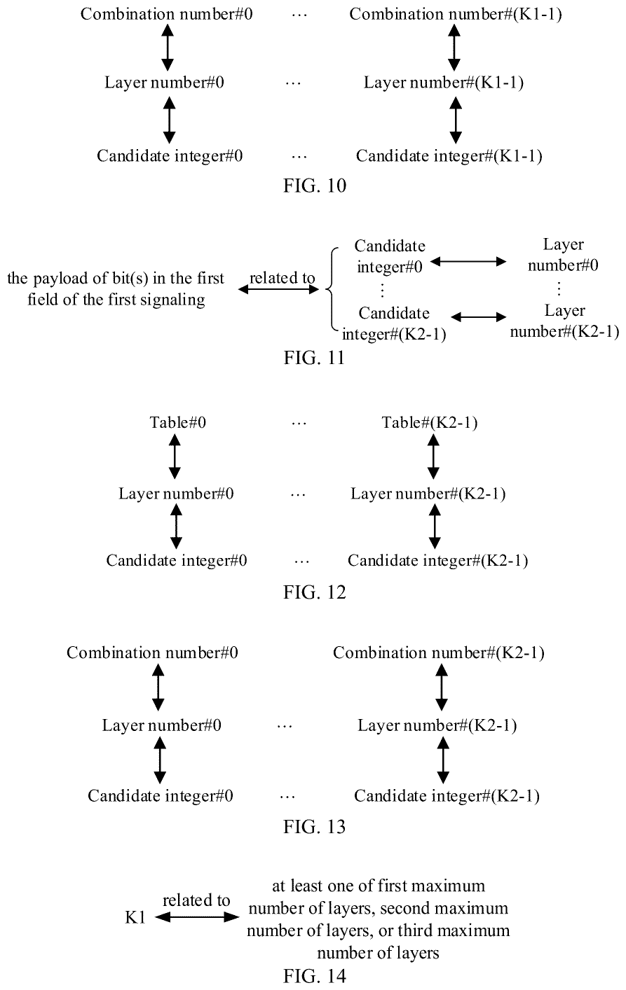

Embodiment 10 illustrates a schematic diagram of K1 numbers of layers, K1 numbers of combinations and K1 candidate integers according to one embodiment of the present application; as shown in FIG. 10. In Embodiment 10, the K1 numbers of layers respectively correspond to K1 numbers of combinations; any of the K1 candidate integers is not less than the corresponding number of combinations. In FIG. 10, the K1 numbers of layers are denoted as layer number #0, . . . , layer number (K1-1), and the K1 numbers of combinations are denoted as combination number #0, combination number (K1-1), and the K1 candidate integers are denoted as candidate integer #0, . . . , candidate integer (K1-1).

In one embodiment, the K1 candidate integers respectively correspond to the K1 numbers of combinations, and the number of combinations corresponding to any one of the K1 candidate integers is: the number of combinations corresponding to the number of layers corresponding to the any one of the candidate integers.

Typically, when a first higher layer parameter is set to “nonCodebook”, the K1 numbers of layers respectively correspond to the K1 numbers of combinations, and any of the K1 candidate integers is not less than a corresponding number of combinations; the first higher layer parameter includes in its name “txConfig”.

In one embodiment, any given candidate integer of the K1 candidate integers is not less than a number of combinations corresponding to the any given candidate integer among the K1 numbers of combinations.

In one embodiment, the K1 numbers of layers are used to determine the K1 numbers of combinations, respectively.

Typically, the K1 candidate integers are equal to the K1 numbers of combinations, respectively.

In one embodiment, any given candidate integer of the K1 candidate integers is equal to a number of combinations corresponding to the any given candidate integer among the K1 numbers of combinations.

In one embodiment, the K1 candidate integers respectively correspond to K1 coefficients, and any of the K1 candidate integers is equal to the sum of a corresponding number of combinations and a corresponding coefficient; the K1 coefficients are non-negative integers, respectively, and at least one of the K1 coefficients is a positive integer.

In one subembodiment, the K1 coefficients are all positive integers.

In one subembodiment, there is one coefficient being equal to 0 among the K1 coefficients.

In one subembodiment, the K1 coefficients are not to be configured.

In one subembodiment, the K1 coefficients are configurable.

Typically, the K1 numbers of combinations are positive integers, respectively.

In one embodiment, the K1 numbers of combinations are positive integers greater than 1, respectively.

In one embodiment, any one of the K1 numbers of combinations is determined by a corresponding number of layers and the second resource number in Embodiment 6 together.

In one embodiment, a first number of combinations is any number of combinations of the K1 numbers of combinations, and a first given number of layers is a number of layers corresponding to the first number of combinations among the K1 numbers of layers; the first number of combinations is equal to a total number of combinations where q1 elements have been taken from p1 different elements, where the p1 is equal to the second resource number, and the q1 is equal to the first given number of layers.

In one embodiment, a first number of combinations is any number of combinations of the K1 numbers of combinations, and a first given number of layers is a number of layers corresponding to the first number of combinations among the K1 numbers of layers; the first number of combinations is denoted as

$$( \begin{matrix}p 1 \\ q 1\end{matrix} )$$

or Cₚ₁^{q1}, where the p1 is equal to the second resource number, and the q1 is equal to the first given number of layers.

In one embodiment, a first number of combinations is any number of combinations of the K1 numbers of combinations, and a first given number of layers is a number of layers corresponding to the first number of combinations among the K1 numbers of layers; the first number of combinations is equal to

$$\\ \frac{p 1 \times ( p 1 - 1 ) \times … \times ( p 1 - q 1 + 1 )}{q 1 \times ( q 1 - 1 ) \times ... \times 1} ,$$

where the p1 is equal to the second resource number, and the q1 is equal to the first given number of layers.

### Embodiment 11

Embodiment 11 illustrates a schematic diagram of a payload of bits included in a first field of a first signaling according to one embodiment of the present application, as shown in FIG. 11. In Embodiment 11, the payload of bit(s) in the first field of the first signaling is related to the K2 candidate integers; the K2 candidate integers respectively correspond to the K2 numbers of layers; the payload of the bit(s) in the first field of the first signaling is no less than a logarithm of a sum of the K2 candidate integers with base 2. In FIG. 11, the K2 numbers of layers are denoted as layer number #0, . . . , layer number # (K2-1), and the K2 candidate integers are denoted as candidate integer #0, candidate integer # (K2-1).

In one embodiment, the K2 numbers of layers are K2 positive integers, respectively.

In one embodiment, the K2 numbers of layers are K2 positive integers not greater than 4, respectively.

In one embodiment, the K2 numbers of layers are K2 positive integers not greater than 8, respectively.

In one embodiment, the K2 numbers of layers are equal to 1, 2 . . . and K2, respectively.

In one embodiment, K2 is equal to K1.

In one embodiment, K2 is not equal to K1.

Typically, the phrase a payload of bit(s) in the first field refers to: a number of bit(s) included in the first field.

Typically, the phrase a payload of bit(s) in the first field refers to: a bitwidth of the first field.

Typically, the payload of the bit(s) in the first field of the first signaling is equal to a smallest positive integer that is no less than the logarithm of a sum of the K2 candidate integers with base 2.

In one embodiment, the payload of the bit(s) in the first field of the first signaling is equal to a nearest integer obtained by rounding up the logarithm of the sum of the K2 candidate integers with base 2.

### Embodiment 12

Embodiment 12 illustrates a schematic diagram of K2 numbers of layers, K2 tables and K2 candidate integers according to one embodiment of the present application; as shown in FIG. 12. In Embodiment 12, the K2 numbers of layers respectively correspond to the K2 tables; a target SRS resource is the first SRS resource of Embodiment 8 or, alternatively, the target SRS resource is one of the first SRS resource or the second SRS resource of Embodiment 8; any of the K2 tables comprises multiple rows, and at least one row in any of the K2 tables indicates a number of layers and a TPMI; if any row in any of the K2 tables indicates a number of layers and a TPMI, the number of layers is equal to a number of layers corresponding to the any table among the K2 numbers of layers, and a number of rows of a precoder corresponding to the TPMI is equal to a number of SRS ports of the target SRS resource; the K2 candidate integers are equal to the numbers of rows included in the K2 tables, respectively.

In one embodiment, any row in any one of the K2 tables indicates a number of layers and a TPMI or is reserved.

In one embodiment, any row in any one of the K2 tables indicates a number of layers and a TPMI.

In one embodiment, a number of layers indicated by any row in any of the K2 tables is equal to a number of layers of the K2 numbers of layers corresponding to the any of the K2 tables, and a number of rows of a precoder corresponding to a TPMI indicated by any row in any of the K2 tables is equal to a number of SRS ports of the target SRS resource.

In one embodiment, when a first higher layer parameter is set to “codebook”, the K2 numbers of layers respectively correspond to the K2 tables, and the K2 candidate integers are equal to the numbers of rows included in the K2 tables, respectively; the first higher layer parameter includes in its name “txConfig”.

In one embodiment, the target SRS resource is the first SRS resource.

In one embodiment, a target SRS resource is one of the first SRS resource or the second SRS resource.

In one embodiment, if any row in any of the K2 tables is reserved, the any row is reserved to a corresponding number of layers.

In one embodiment, if any row in any of the K2 tables indicates a TPMI and a number of layers, the any row indicates only a TPMI and a number of layers.

In one embodiment, a value of “codebookSubset” corresponding to any one of the K2 tables is equal to a fourth higher layer parameter value.

In one embodiment, any given table of the K2 tables comprises all or part of rows corresponding to a given number of layers in a portion of a Table of Table 7.3.1.1.2-2, Table 7.3.1.1.2-2A, Table 7.3.1.1.2-2B, Table 7.3.1.1.2-2C, Table 7.3.1.1.2-2D, of 3GPP TS38.212. Table 7.3.1.1.2-2E, Table 7.3.1.1.2-3, Table 7.3.1.1.2-3A, Table 7.3.1.1.2-4, Table 7.3.1.1.2-4A, Table 7.3.1.1.2-4B, Table 7.3.1.1.2-4C, Table 7.3.1.1.2-5, or Table 7.3.1.1.2-5A, of which a corresponding “codebookSubset” is equal to a fourth higher layer parameter value, where the given number of layers is a number of layers corresponding to the any given table as described above.

In one embodiment, the fourth higher layer parameter value is the value of a higher layer parameter “codebookSubset” that the first node is configured with.

In one embodiment, the fourth higher layer parameter value is the value of a higher layer parameter “codebookSubset” that the first node is configured with and that corresponds to an SRS resource set to which the target SRS resource belongs.

In one embodiment, the fourth higher layer parameter value is equal to one of “fullyAndPartialAndNonCoherent”, “partialAndNonCoherent” or “nonCoherent”.

In one embodiment, the first field of the first signaling indicates from the K2 tables a precoder for the first sub-signal and a number of layers of the first sub-signal.

### Embodiment 13

Embodiment 13 illustrates a schematic diagram of K2 numbers of layers, K2 numbers of combinations and K2 candidate integers according to one embodiment of the present application; as shown in FIG. 13. In Embodiment 13, the K2 numbers of layers respectively correspond to the K2 numbers of combinations, and the K2 numbers of layers are used to determine the K2 numbers of combinations; a target resource number is the first resource number of Embodiment 6 or, alternatively, the target resource number is one of the first resource number or the second resource number of Embodiment 6; any number of combinations of the K2 numbers of combinations is equal to a total number of combinations in which elements of which the number is equal to a corresponding number of layers are taken from different elements of which the number is equal to the target resource number; the K2 candidate integers are equal to the K2 numbers of combinations, respectively.

In one embodiment, when a first higher layer parameter is set to “nonCodebook”, the K2 numbers of layers respectively correspond to the K2 numbers of combinations, and the K2 candidate integers are equal to the K2 numbers of combinations, respectively; the first higher layer parameter includes in its name “txConfig”.

In one embodiment, the target resource number is the first resource number.

In one embodiment, the target resource number is one of the first resource number or the second resource number.

In one embodiment, a second number of combinations is any number of combinations of the K2 numbers of combinations, and a second given number of layers is a number of layers corresponding to the second number of combinations among the K2 numbers of layers; the second number of combinations is denoted as

$$( \begin{matrix}p 2 \\ q 2\end{matrix} )$$

or Cₚ₂^{q2}, where p2 is equal to the target resource number, and q2 is equal to the second given number of layers.

### Embodiment 14

Embodiment 14 illustrates a schematic diagram of relating K1 to at least one of a first maximum number of layers, a second maximum number of layers, or a third maximum number of layers according to one embodiment of the present application; as shown in FIG. 14.

In one embodiment, the first maximum number of layers is configured by a higher layer parameter.

In one subembodiment, the higher layer parameter configuring the first maximum number of layers includes “maxMIMO-Layers” or “maxRank” in its name.

In one embodiment, the first maximum number of layers is applied to the first SRS resource set in Embodiment 6.

In one embodiment, the first maximum number of layers is applied to only the first SRS resource set of the first SRS resource set and the second SRS resource set in Embodiment 6, or, the first maximum number of layers is applied to the first SRS resource set and the second SRS resource set in Embodiment 6.

In one embodiment, the second maximum number of layers is configured by a higher layer parameter.

In one subembodiment, the higher layer parameter configuring the second maximum number of layers includes “maxMIMO-Layers” or “maxRank” in its name.

In one embodiment, the second maximum number of layers is applied to the second SRS resource set in Embodiment 6.

In one embodiment, the second maximum number of layers is applied to only the second SRS resource set of the first SRS resource set and the second SRS resource set in Embodiment 6.

In one embodiment, the first maximum number of layers and the second maximum number of layers are configured separately.

Typically, when the first node is configured with two maximum numbers of layers respectively applied to the first SRS resource set and the second SRS resource set in Embodiment 6, the first maximum number of layers is the maximum number of layers applied to the first SRS resource set between the two maximum numbers of layers, and the second maximum number of layers is the maximum number of layers applied to the second SRS resource set between the two maximum numbers of layers.

In one subembodiment, the first maximum number of layers is not applied to the second SRS resource set and the second maximum number of layers is not applied to the first SRS resource set.

Typically, when the first node is configured with one maximum number of layers applied to both the first SRS resource set and the second SRS resource set, the first maximum number of layers is the one maximum number of layers.

In one embodiment, the sentence that one maximum number of layers is applied to one SRS resource set includes that a number of layers of a signal being transmitted by the same antenna port(s) as the SRS port(s) of at least one SRS resource in the one SRS resource set is not greater than the one maximum number of layers.

In one embodiment, the sentence that one maximum number of layers is applied to one SRS resource set includes that a greatest value of a number of layers of a signal being transmitted by the same antenna port(s) as the SRS port(s) of at least one SRS resource in the one SRS resource set is equal to the one maximum number of layers.

In one embodiment, the sentence that one maximum number of layers is not applied to one SRS resource set includes that a number of layers of a signal being transmitted by the same antenna port(s) as the SRS port(s) of at least one SRS resource in the one SRS resource set is not limited to the one maximum number of layers.

In one embodiment, the sentence that one maximum number of layers is not applied to one SRS resource set includes that a greatest value of a number of layers of a signal being transmitted by the same antenna port(s) as the SRS port(s) of at least one SRS resource in the one SRS resource set is unrelated to the one maximum number of layers.

In one embodiment, the sentence that one maximum number of layers is not applied to one SRS resource set includes that a greatest value of a number of layers of a signal being transmitted by the same antenna port(s) as the SRS port(s) of at least one SRS resource in the one SRS resource set and the one maximum number of layers are separately configured.

In one embodiment, the third maximum number of layers is configured by a higher layer parameter.

In one subembodiment, the higher layer parameter configuring the third maximum number of layers includes “maxMIMO-Layers” or “maxRank” in its name.

In one embodiment, the third maximum number of layers is a greatest value of the sum of a number of layers of signals transmitted on the same antenna ports as the SRS ports of SRS resources in the first SRS resource set and a number of layers of signals transmitted on the same antenna ports as the SRS ports of SRS resources in the second SRS resource set.

In one embodiment, the third maximum number of layers and the first maximum number of layers are configured separately.

In one embodiment, the third maximum number of layers, the first maximum number of layers and the second maximum number of layers are configured separately.

In one embodiment, the phrase configured separately includes: being configured respectively by different higher layer parameters, the different higher layer parameters having different names.

In one embodiment, the phrase configured separately includes: being configured to different values by a same higher layer parameter.

In one embodiment, on the basis of configuration of the first maximum number of layers, the third maximum number of layers need not be additionally configured.

In one embodiment, on the basis of configuration of the first maximum number of layers and the second maximum number of layers, the third maximum number of layers need not be additionally configured.

In one embodiment, on the basis of at least one of the first maximum number of layers and the second maximum number of layers being configured, the third maximum number of layers need not be additionally configured.

In one embodiment, the sentence that the third maximum number of layers need not be additionally configured means that the third maximum number of layers can be obtained from the first maximum number of layers.

In one embodiment, the sentence that the third maximum number of layers need not be additionally configured means that the third maximum number of layers can be obtained from the first maximum number of layers and the second maximum number of layers.

In one embodiment, the third maximum number of layers is equal to the first maximum number of layers.

In one embodiment, the third maximum number of layers is equal to one of the first maximum number of layers or the second maximum number of layers.

In one embodiment, the third maximum number of layers is equal to a greater one of the first maximum number of layers and the second maximum number of layers.

In one embodiment, the third maximum number of layers is equal to the sum of the first maximum number of layers and the second maximum number of layers.

In one embodiment, the third maximum number of layers is no less than the first maximum number of layers.

In one embodiment, the third maximum number of layers is no less than the first maximum number of layers and no less than the second maximum number of layers.

In one embodiment, the first node is configured with at least the first maximum number of layers of the first maximum number of layers, the second maximum number of layers and the third maximum number of layers.

In one embodiment, which number(s) of layers of the first maximum number of layers, the second maximum number of layers and the third maximum number of layers the first node is configured with is related to whether a time-domain resource occupied by the first sub-signal overlaps with a time-domain resource occupied by the second sub-signal.

In one embodiment, when the time-domain resource occupied by the first sub-signal and the time-domain resource occupied by the second sub-signal are orthogonal to each other, the first node is configured with only the first maximum number of layers of the first maximum number of layers, the second maximum number of layers and the third maximum number of layers.

In one embodiment, when the time-domain resource occupied by the first sub-signal and the time-domain resource occupied by the second sub-signal are orthogonal to each other, the first node is configured with only the first maximum number of layers and the second maximum number of layers of the first maximum number of layers, the second maximum number of layers and the third maximum number of layers.

In one embodiment, when the time-domain resource occupied by the first sub-signal and the time-domain resource occupied by the second sub-signal are overlapped, the first node is configured with the first maximum number of layers, and also with at least one of the second maximum number of layers or the third maximum number of layers.

In one embodiment, when and only when the time-domain resource occupied by the first sub-signal and the time-domain resource occupied by the second sub-signal are overlapped, the first node is configured with at least one of the second maximum number of layers or the third maximum number of layers.

In one embodiment, when and only when the time-domain resource occupied by the first sub-signal and the time-domain resource occupied by the second sub-signal are overlapped, the first node is configured with the third maximum number of layers.

In one embodiment, when the time-domain resource occupied by the first sub-signal and the time-domain resource occupied by the second sub-signal are orthogonal to each other, the first node is configured with only the first maximum number of layers of the first maximum number of layers, the second maximum number of layers and the third maximum number of layers; when the time-domain resource occupied by the first sub-signal and the time-domain resource occupied by the second sub-signal are overlapped, the first node is configured with the first maximum number of layers, and also with at least one of the second maximum number of layers or the third maximum number of layers.

In one embodiment, when the time-domain resource occupied by the first sub-signal and the time-domain resource occupied by the second sub-signal are orthogonal to each other, the first node is configured with only the first maximum number of layers and the second maximum number of layers of the first maximum number of layers, the second maximum number of layers and the third maximum number of layers; when the time-domain resource occupied by the first sub-signal and the time-domain resource occupied by the second sub-signal are overlapped, the first node is configured with the first maximum number of layers and the second maximum number of layers as well as with the third maximum number of layers.

In one embodiment, at least one of the first maximum number of layers, the second maximum number of layers or the third maximum number of layers is used to determine the K1.

In one embodiment, K1 is related only to the first maximum number of layers of the first maximum number of layers, the second maximum number of layers and the third maximum number of layers.

In one embodiment, K1 is related to the first maximum number of layers.

In one embodiment, K1 is equal to the first maximum number of layers.

In one embodiment, K1 is equal to a smallest value of the first maximum number of layers and the second resource number in Embodiment 6.

In one embodiment, K1 is equal to the first maximum number of layers minus a first coefficient, the first coefficient being a positive integer.

In one embodiment, K1 is equal to a smallest value of the difference obtained by subtracting a first coefficient from the first maximum number of layers and the second resource number in Embodiment 6, the first coefficient being a positive integer.

In one embodiment, K1 is related only to the second maximum number of layers of the first maximum number of layers, the second maximum number of layers and the third maximum number of layers.

In one embodiment, K1 is related to the second maximum number of layers.

In one embodiment, K1 is equal to the second maximum number of layers.

In one embodiment, K1 is equal to a smallest value of the second maximum number of layers and the second resource number in Embodiment 6.

In one embodiment, K1 is equal to the second maximum number of layers minus a first coefficient, the first coefficient being a positive integer.

In one embodiment, K1 is equal to a smallest value of the difference obtained by subtracting a first coefficient from the second maximum number of layers and the second resource number in Embodiment 6, the first coefficient being a positive integer.

In one embodiment, K1 is related only to the first maximum number of layers and the third maximum number of layers of the first maximum number of layers, the second maximum number of layers and the third maximum number of layers.

In one embodiment, K1 is related to both the first maximum number of layers and the third maximum number of layers.

In one embodiment, K1 is equal to a smallest value of the first maximum number of layers and the difference obtained by subtracting a first coefficient from the third maximum number of layers, the first coefficient being a positive integer.

In one embodiment, K1 is equal to a smallest value of the first maximum number of layers, the difference obtained by subtracting a first coefficient from the third maximum number of layers and the second resource number in Embodiment 6, the first coefficient being a positive integer.

In one embodiment, K1 is related only to the second maximum number of layers and the third

maximum number of layers of the first maximum number of layers, the second maximum number of layers and the third maximum number of layers.

In one embodiment, K1 is related to both the second maximum number of layers and the third maximum number of layers.

In one embodiment, K1 is equal to a smallest value of the second maximum number of layers and the difference obtained by subtracting a first coefficient from the third maximum number of layers, the first coefficient being a positive integer.

In one embodiment, K1 is equal to a smallest value of the second maximum number of layers, the difference obtained by subtracting a first coefficient from the third maximum number of layers and the second resource number in Embodiment 6, the first coefficient being a positive integer.

In one embodiment, K1 is related to the first maximum number of layers, the second maximum number of layers and the third maximum number of layers.

In one embodiment, the first coefficient is fixed to 1.

In one embodiment, the first coefficient is greater than 1.

In one embodiment, the first coefficient is not in need of configuration.

In one embodiment, the first coefficient is configurable.

In one embodiment, the first coefficient is configured by RRC signaling.

In one embodiment, the first coefficient is configured by a MAC CE.

In one embodiment, the first coefficient is configured by DCI.

In one embodiment, the first coefficient is equal to the number of layers of the first sub-signal.

### Embodiment 15

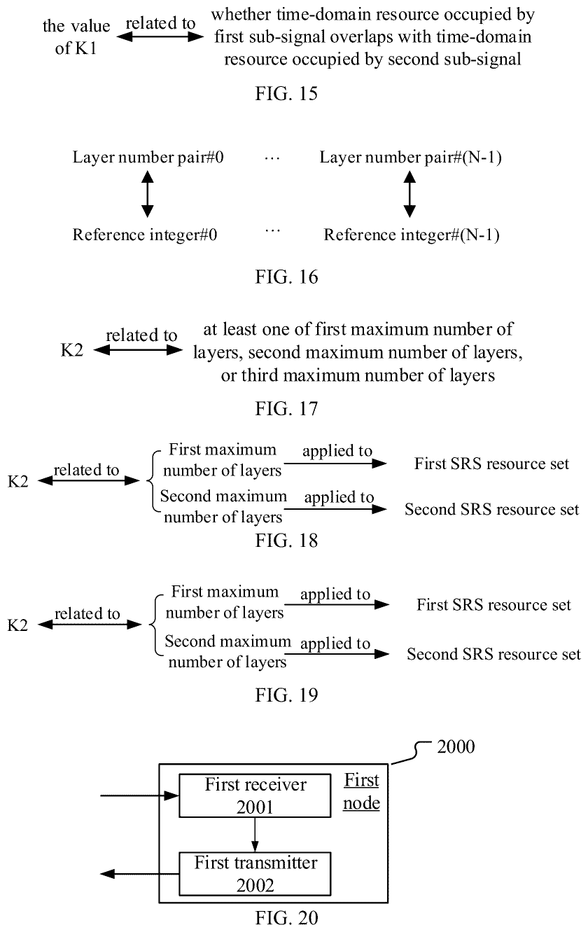

Embodiment 15 illustrates a schematic diagram of relating the value of K1 to whether a time-domain resource occupied by a first sub-signal overlaps with a time-domain resource occupied by a second sub-signal according to one embodiment of the present application; as shown in FIG. 15.

In one embodiment, when the time-domain resource occupied by the first sub-signal and the time-domain resource occupied by the second sub-signal are orthogonal to each other, K1 is related only to a fifth maximum number of layers of the first maximum number of layers, the second maximum number of layers and the third maximum number of layers; the fifth maximum number of layers either being the first maximum number of layers or being the second maximum number of layers.

In one embodiment, when the time-domain resource occupied by the first sub-signal and the time-domain resource occupied by the second sub-signal are mutually orthogonal, K1 is equal to the fifth maximum number of layers.

In one embodiment, when the time-domain resource occupied by the first sub-signal and the time-domain resource occupied by the second sub-signal are mutually orthogonal, K1 is equal to a smallest value of the fifth maximum number of layers and the second resource number of Embodiment 6.

In one embodiment, when the first node is configured with the first maximum number of layers and the second maximum number of layers respectively applied to the first SRS resource set and the second SRS resource set in Embodiment 6, the fifth maximum number of layers is the second maximum number of layers; when the first node is configured with the first maximum number of layers not only applied to the first SRS resource set but also applied to the second SRS resource set, the fifth maximum number of layers is the first maximum number of layers.

In one embodiment, when the time-domain resource occupied by the first sub-signal and the time-domain resource occupied by the second sub-signal are overlapped, K1 is related to the third maximum number of layers.

In one embodiment, when the time-domain resource occupied by the first sub-signal and the time-domain resource occupied by the second sub-signal are overlapped, K1 is equal to the third maximum number of layers minus the first coefficient of Embodiment 14.

In one embodiment, when the time-domain resource occupied by the first sub-signal and the time-domain resource occupied by the second sub-signal are overlapped, K1 is equal to a smallest value of the difference obtained by subtracting the first coefficient of Embodiment 14 from the third maximum number of layers and the second resource number of Embodiment 6.

In one embodiment, when the time-domain resource occupied by the first sub-signal and the time-domain resource occupied by the second sub-signal are overlapped, K1 is related to both a fourth maximum number of layers and the third maximum number of layers of the first maximum number of layers, the second maximum number of layers and the third maximum number of layers; the fourth maximum number of layers either being the first maximum number of layers or being the second maximum number of layers.

In one embodiment, when the time-domain resource occupied by the first sub-signal and the time-domain resource occupied by the second sub-signal are overlapped, K1 is equal to a smallest value of the fourth maximum number of layers and the difference obtained by subtracting the first coefficient of Embodiment 14 from the third maximum number of layers.

In one embodiment, when the time-domain resource occupied by the first sub-signal and the time-domain resource occupied by the second sub-signal are overlapped, K1 is equal to a smallest value among the fourth maximum number of layers, the difference obtained by subtracting the first coefficient of Embodiment 14 from the third maximum number of layers and the second resource number of Embodiment 6.

In one embodiment, when the first node is configured with the first maximum number of layers and the second maximum number of layers respectively applied to the first SRS resource set and the second SRS resource set in Embodiment 6, the fourth maximum number of layers is the second maximum number of layers; when the first node is configured with the first maximum number of layers not only applied to the first SRS resource set but also applied to the second SRS resource set, the fourth maximum number of layers is the first maximum number of layers.

In one embodiment, when the time-domain resource occupied by the first sub-signal and the time-domain resource occupied by the second sub-signal are mutually orthogonal, K1 is equal to the fifth maximum number of layers; when the time-domain resource occupied by the first sub-signal and the time-domain resource occupied by the second sub-signal are overlapped, K1 is equal to the third maximum number of layers minus the first coefficient of Embodiment 14.

In one embodiment, when the time-domain resource occupied by the first sub-signal and the time-domain resource occupied by the second sub-signal are mutually orthogonal, K1 is equal to the fifth maximum number of layers; when the time-domain resource occupied by the first sub-signal and the time-domain resource occupied by the second sub-signal are overlapped, K1 is equal to a smallest value of the fourth maximum number of layers and the difference obtained by subtracting the first coefficient of Embodiment 14 from the third maximum number of layers.

In one embodiment, when the time-domain resource occupied by the first sub-signal and the time-domain resource occupied by the second sub-signal are mutually orthogonal, K1 is equal to a smallest value of the fifth maximum number of layers and the second resource number of Embodiment 6; when the time-domain resource occupied by the first sub-signal and the time-domain resource occupied by the second sub-signal are overlapped, K1 is equal to a smallest value of the difference obtained by subtracting the first coefficient of Embodiment 14 from the third maximum number of layers and the second resource number of Embodiment 6.

In one embodiment, when the time-domain resource occupied by the first sub-signal and the time-domain resource occupied by the second sub-signal are mutually orthogonal, K1 is equal to a smallest value of the fifth maximum number of layers and the second resource number of Embodiment 6; when the time-domain resource occupied by the first sub-signal and the time-domain resource occupied by the second sub-signal are overlapped, K1 is equal to a smallest value among the fourth maximum number of layers, the difference obtained by subtracting the first coefficient of Embodiment 14 from the third maximum number of layers and the second resource number of Embodiment 6.

In one embodiment, regardless of whether the time-domain resource occupied by the first sub-signal and the time-domain resource occupied by the second sub-signal are overlapped, the K1 numbers of layers are equal to 1, 2 . . . , and K1, respectively.

In one embodiment, the value of the K1 numbers of layers is related to whether the time-domain resource occupied by the first sub-signal overlaps with the time-domain resource occupied by the second sub-signal.

In one embodiment, when the time-domain resource occupied by the first sub-signal and the time-domain resource occupied by the second sub-signal are mutually orthogonal, the K1 numbers of layers are equal to 1, 2 . . . , and K1, respectively.

In one embodiment, K1 is related to the number of layers of the first sub-signal.

In one embodiment, the value of the K1 numbers of layers is related to the number of layers of the first sub-signal.

In one embodiment, when the time-domain resource occupied by the first sub-signal and the time-domain resource occupied by the second sub-signal are overlapped, K1 is equal to a second reference integer minus a first reference integer plus 1; the first reference integer is equal to a smallest value comparing a maximum value between the difference obtained by subtracting a second coefficient from the number of layers of the first sub-signal and 1, with the fourth maximum number of layers, the second reference integer is equal to a smallest value among the four of the sum of the number of layers of the first sub-signal and the second coefficient, the fourth maximum number of layers, the difference obtained by subtracting the number of layers of the first sub-signal from the third maximum number of layers, and the second resource number; the second coefficient is a non-negative integer.

In one subembodiment, the K1 numbers of layers are equal to the first reference integer, the first reference integer +1, . . . and the second reference integer, respectively.

In one subembodiment, the second coefficient is default.

In one subembodiment, the second coefficient is fixed.

In one subembodiment, the second coefficient is configured by a higher layer signaling.

In one subembodiment, the second coefficient is equal to 0.

In one subembodiment, the second coefficient is greater than 0.

In one embodiment, when the time-domain resource occupied by the first sub-signal and the time-domain resource occupied by the second sub-signal are overlapped, K1 is equal to the smallest value of a third coefficient, the difference obtained by subtracting the number of layers of the first sub-signal from the third maximum number of layers, and the second resource number; the third coefficient is a positive integer.

In one subembodiment, the third coefficient is default.

In one subembodiment, the third coefficient is fixed.

In one subembodiment, the third coefficient is configured by a higher layer signaling.

In one subembodiment, the third coefficient is equal to 2 multiplied by a second coefficient, the second

coefficient being a positive integer, the second coefficient being configured by a higher layer signaling.

### Embodiment 16

Embodiment 16 illustrates a schematic diagram of relating the value of K1 to whether a time-domain resource occupied by a first sub-signal overlaps with a time-domain resource occupied by a second sub-signal according to one embodiment of the present application; as shown in FIG. 16. In Embodiment 16, when the time-domain resource occupied by the first sub-signal and the time-domain resource occupied by the second sub-signal are overlapped, the payload of bit(s) in the second field of the first signaling is related to N pairs of numbers of layers, N being equal to the first maximum number of layers; any one of the N pairs of numbers of layers comprises two numbers of layers; the N pairs of numbers of layers respectively correspond to N reference integers; the payload of the bit(s) in the second field of the first signaling is not less than the logarithm of a greatest value of the N reference integers with a base of 2; a first reference pair of numbers of layers is one of the N pairs of numbers of layers, K1 is equal to an absolute value of the difference between the two numbers of layers in the first reference pair of numbers of layers plus 1, the K1 numbers of layers are equal to a first number of layers in the first reference pair of numbers of layers, the first number of layers in the first reference pair of numbers of layers +1, . . . and a second number of layers in the first reference pair of numbers of layers.

In one embodiment, a second number of layers is greater than a first number of layers in any one of the N pairs of numbers of layers.

In one embodiment, the first reference pair of numbers of layers is any one of the N pairs of numbers of layers.

In one embodiment, the payload of the bit(s) in the second field of the first signaling is equal to a

nearest integer obtained by rounding up the logarithm of a greatest value of the N reference integers with a base of 2.

In one embodiment, the first reference pair of numbers of layers is one of the N pairs of numbers of layers corresponding to a largest value of the N reference integers.

In one embodiment, the N pairs of numbers of layers respectively correspond to N reference numbers of layers, the N reference numbers of layers being equal to 1 . . . , N, respectively; a first number of layers in any of the N pairs of numbers of layers is equal to the maximum value between the difference obtained by subtracting a second coefficient from a corresponding reference number of layers and 1, and a second number of layers in any of the N pairs of numbers of layers is equal to the smallest value between the sum of a corresponding reference number of layers and the second coefficient, and the third maximum number of layers minus the corresponding reference number of layers; the second coefficient is a positive integer.

In one embodiment, the N pairs of numbers of layers respectively correspond to N reference numbers of layers, the N reference numbers of layers being equal to 1 . . . , N, respectively; a first number of layers in any of the N pairs of numbers of layers is equal to the maximum value between the difference obtained by subtracting a second coefficient from a corresponding reference number of layers and 1, and a second number of layers in any of the N pairs of numbers of layers is equal to the smallest value among the sum of a corresponding reference number of layers and the second coefficient, the fourth maximum number of layers and the third maximum number of layers minus the corresponding reference number of layers; the second coefficient is a positive integer.

In one embodiment, the N pairs of numbers of layers respectively correspond to N reference numbers of layers, the N reference numbers of layers being equal to 1 . . . , N, respectively; a first number of layers in any of the N pairs of numbers of layers is equal to the maximum value between the difference obtained by subtracting a second coefficient from a corresponding reference number of layers and 1, and a second number of layers in any of the N pairs of numbers of layers is equal to the smallest value among the sum of a corresponding reference number of layers and the second coefficient, the third maximum number of layers minus the corresponding reference number of layers and the second resource number; the second coefficient is a positive integer.

In one embodiment, the N pairs of numbers of layers respectively correspond to N reference numbers of layers, the N reference numbers of layers being equal to 1 . . . , N, respectively; a first number of layers in any of the N pairs of numbers of layers is equal to the maximum value between the difference obtained by subtracting a second coefficient from a corresponding reference number of layers and 1, and a second number of layers in any of the N pairs of numbers of layers is equal to the smallest value among the sum of a corresponding reference number of layers and the second coefficient, the third maximum number of layers minus the corresponding reference number of layers, the fourth maximum number of layers of Embodiment 15 and the second resource number; the second coefficient is a positive integer.

In one embodiment, the N pairs of numbers of layers respectively correspond to N reference numbers of layers, the N reference numbers of layers being equal to 1 . . . , N, respectively; a first number of layers in any of the N pairs of numbers of layers is equal to a smallest value comparing the maximum value between the difference obtained by subtracting a second coefficient from a corresponding reference number of layers and 1 with the fourth maximum number of layers of Embodiment 15, and a second number of layers in any of the N pairs of numbers of layers is equal to the smallest value among the sum of a corresponding reference number of layers and the second coefficient, the third maximum number of layers minus the corresponding reference number of layers, the fourth maximum number of layers and the second resource number; the second coefficient is a positive integer.

In one embodiment, the N pairs of numbers of layers respectively correspond to N groups of tables, and the N groups of tables respectively correspond to the N reference integers; a given group of tables is any of the N groups of tables, and a given pair of numbers of layers is a pair of numbers of layers among the N pairs of numbers of layers corresponding to the given group of tables; the given group of tables comprises S tables, the S being equal to the second number of layers minus the first number of layers in the given pair of numbers of layers further plus 1, the S tables respectively corresponding to S numbers of layers, the S numbers of layers being equal to the first number of layers in the given pair of numbers of layers, the first number of layers in the given pair of numbers of layers +1, . . . and the second number of layers in the given pair of numbers of layers; a given table is any one of the S tables, the given table corresponding to a given number of layers of the S numbers of layers; the given table comprises multiple rows, any row in the given table indicating a number of layers and a TPMI; a number of layers indicated by any row in the given table is equal to the given number of layers; and a reference integer corresponding to the given pair of numbers of layers among the N reference integers is equal to the sum of numbers of rows included in the S tables.

In one subembodiment, a number of rows of a corresponding precoder for a TPMI indicated by any row of the given table is equal to a number of SRS ports of the second SRS resource of Embodiment 8.

In one subembodiment, the second field of the first signaling indicates a precoder for the second sub-signal from one of the N groups of tables.

In one subembodiment, a target reference number of layers is a number of layers of the first sub-signal, and the second field of the first signaling indicates a precoder for the second sub-signal and a number of layers of the second sub-signal from a group of tables among the N groups of tables that corresponds to a pair of numbers of layers corresponding to the target reference number of layers.

In one embodiment, the N pairs of numbers of layers respectively correspond to N groups of numbers of combinations; a given group of numbers of combinations is any group of numbers of combinations among the N groups of numbers of combinations, and a given pair of numbers of layers is a pair of numbers of layers corresponding to the given group of numbers of combinations among the N pairs of numbers of layers; the given group of numbers of combinations comprises S numbers of combinations, the S being equal to the second number of layers minus the first number of layers in the given pair of numbers of layers further plus 1, the S tables respectively corresponding to S numbers of layers, the S numbers of layers being equal to the first number of layers in the given pair of numbers of layers, the first number of layers in the given pair of numbers of layers +1 . . . and the second number of layers in the given pair of numbers of layers, respectively; a given number of combinations is any number of combinations of the S numbers of combinations, the given number of combinations corresponding to a given number of layers of the S numbers of layers; the given number of combinations is equal to a total number of combinations in which elements of which the number is equal to the given number of layers are taken from different elements of which the number is equal to the second resource number in Embodiment 6; a reference integer corresponding to the given pair of numbers of layers among the N reference integers is equal to the sum of the S numbers of combinations.

### Embodiment 17

Embodiment 17 illustrates a schematic diagram of relating K2 to at least one of a first maximum number of layers, a second maximum number of layers, or a third maximum number of layers according to one embodiment of the present application; as shown in FIG. 17.

In one embodiment, at least one of the first maximum number of layers, the second maximum number of layers or the third maximum number of layers is used to determine the K2.

In one embodiment, K2 is related only to the first maximum number of layers of the first maximum number of layers, the second maximum number of layers and the third maximum number of layers.

In one embodiment, K2 is related to the first maximum number of layers.

In one embodiment, K2 is equal to the first maximum number of layers.

In one embodiment, K2 is equal to a smallest value of the first maximum number of layers and the first resource number in Embodiment 6.

In one embodiment, K2 is always equal to the first maximum number of layers, regardless of the relative magnitude of the first maximum number of layers and the second maximum number of layers.

In one embodiment, K2 is always equal to a smallest value of the first maximum number of layers and the first resource number in Embodiment 6, regardless of the relative magnitude of the first maximum number of layers and the second maximum number of layers.

In one embodiment, K2 is related only to the first maximum number of layers and the second maximum number of layers of the first maximum number of layers, the second maximum number of layers and the third maximum number of layers.

In one embodiment, K2 is related to both the first maximum number of layers and the second maximum number of layers.

In one embodiment, K2 is equal to a greatest value of the first maximum number of layers and the second maximum number of layers.

In one embodiment, K2 is equal to a smallest value of a target maximum number of layers and a target resource number, and the target maximum number of layers is equal to a greatest value of the first maximum number of layers and the second maximum number of layers; if the target maximum number of layers is equal to the first maximum number of layers, the target resource number is equal to the first resource number in Embodiment 6; if the target maximum number of layers is equal to the second maximum number of layers, the target resource number is equal to the second resource number in Embodiment 6.

In one embodiment, a value of K2 is related to the first maximum number of layers, the second maximum number of layers, and a number of SRS ports of the first SRS resource and a number of SRS ports of the second SRS resource in Embodiment 8.

In one embodiment, a value of K2 is related to the first maximum number of layers, the second maximum number of layers, and the first resource number and the second resource number in Embodiment 6.

In one embodiment, K2 is equal to a smallest value of a target maximum number of layers and a target resource number, and the target maximum number of layers is equal to the first maximum number of layers or the second maximum number of layers; if the target maximum number of layers is equal to the first maximum number of layers, the target resource number is equal to the first resource number in Embodiment 6; if the target maximum number of layers is equal to the second maximum number of layers, the target resource number is equal to the second resource number in Embodiment 6.

In one subembodiment, whether the target maximum number of layers is equal to the first maximum number of layers or the second maximum number of layers is related to the first maximum number of layers, the second maximum number of layers, and a number of SRS ports of the first SRS resource and a number of SRS ports of the second SRS resource in Embodiment 8.

In one subembodiment, whether the target maximum number of layers is equal to the first maximum number of layers or the second maximum number of layers is related to the first maximum number of layers, the second maximum number of layers, and the first resource number and the second resource number in Embodiment 6.

In one embodiment, K2 is related only to the first maximum number of layers and the third maximum number of layers of the first maximum number of layers, the second maximum number of layers and the third maximum number of layers.

In one embodiment, K2 is related to both the first maximum number of layers and the third maximum number of layers.

In one embodiment, K2 is related to the first maximum number of layers, the second maximum number of layers and the third maximum number of layers.

In one embodiment, the payload of the bit(s) in the first field of the first signaling is not related to whether a time-domain resource occupied by the first sub-signal overlaps with a time-domain resource occupied by the second sub-signal.

In one embodiment, regardless of whether the time-domain resource occupied by the first sub-signal overlaps with the time-domain resource occupied by the second sub-signal, the payload of each bit in the first field of the first signaling is equal to the logarithm of the sum of the K2 candidate integers with base 2.

In one embodiment, a value of K2 is unrelated to whether the time-domain resource occupied by the first sub-signal overlaps with the time-domain resource occupied by the second sub-signal.

In one embodiment, a value of K2 is related to whether the time-domain resource occupied by the first sub-signal overlaps with the time-domain resource occupied by the second sub-signal.

### Embodiment 18

Embodiment 18 illustrates a schematic diagram of relating K2 to a first maximum number of layers and a second maximum number of layers according to one embodiment of the present application; as shown in FIG. 18. In Embodiment 18, K2 is related to the first maximum number of layers and the second maximum number of layers; the first maximum number of layers and the second maximum number of layers are configured separately; the first maximum number of layers is applied to the first SRS resource set in Embodiment 6, and the second maximum number of layers is applied to the second SRS resource set in Embodiment 6; K2 is equal to a target maximum number of layers, the target maximum number of layers being equal to the first maximum number of layers or the second maximum number of layers, a first higher layer parameter is set to “codebook”, and the first higher layer parameter includes “txConfig” in its name.

In one embodiment, whether the target maximum number of layers is equal to the first maximum number of layers or the second maximum number of layers is related to both a number of SRS ports of the first SRS resource and a number of SRS ports of the second SRS resource in Embodiment 8.

In one embodiment, when a number of SRS ports of the first SRS resource and a number of SRS ports of the second SRS resource in Embodiment 8 are unequal, if the number of SRS ports of the first SRS resource is greater than the number of SRS ports of the second SRS resource, the target maximum number of layers is equal to the first maximum number of layers; if the number of SRS ports of the first SRS resource is less than the number of SRS ports of the second SRS resource, the target maximum number of layers is equal to the second maximum number of layers.

In one embodiment, when the number of SRS ports of the first SRS resource is equal to the number of SRS ports of the second SRS resource, the target maximum number of layers is equal to a maximum number of layers between the first maximum number of layers and the second maximum number of layers that is applied to one SRS resource set with a smaller SRS-ResourceSetId of the first SRS resource set and the second SRS resource set.

In one embodiment, when the number of SRS ports of the first SRS resource is equal to the number of SRS ports of the second SRS resource, the target maximum number of layers is equal to a greater one of the first maximum number of layers and the second maximum number of layers.

In one embodiment, the number of SRS ports of the first SRS resource is equal to a first port number, and the number of SRS ports of the second SRS resource is equal to a second port number; S1 reference numbers of layers are respectively used together with the first port number to determine S1 tables, S1 being equal to the first maximum number of layers, the S1 reference numbers of layers being equal to 1, 2 . . . , and S1, respectively; S2 reference numbers of layers are respectively used together with the second port number to determine S2 tables, S2 being equal to the second maximum number of layers, the S2 reference numbers of layers being equal to 1, 2, . . . , S2, respectively; any table of the S1 tables and the S2 tables comprising multiple rows; any row in any of the S1 tables indicates a number of layers and a TPMI, and a number of layers indicated by any row in any of the S1 tables is equal to a corresponding reference number of layers, and a number of rows of a precoder corresponding to a TPMI indicated by any row in any of the S1 tables is equal to the first port number; any row in any of the S2 tables indicates a number of layers and a TPMI, and a number of layers indicated by any row in any of the S2 tables is equal to a corresponding reference number of layers, and a number of rows of a precoder corresponding to a TPMI indicated by any row in any of the S2 tables is equal to the second port number; when a total number of rows included in the S1 tables is greater than a total number of rows included in the S2 tables, the target maximum number of layers is the first maximum number of layers; when a total number of rows included in the S1 tables is less than a total number of rows included in the S2 tables, the target maximum number of layers is the second maximum number of layers.

In one subembodiment, when the total number of rows included in the S1 tables is equal to the total number of rows included in the S2 tables, the target maximum number of layers is either the first maximum number of layers or the second maximum number of layers.

In one subembodiment, the first field of the first signaling indicates a precoder for the first sub-signal from the S1 tables, or, the first field of the first signaling indicates a precoder for the first sub-signal from the S2 tables.

In one subembodiment, when the total number of rows included in the S1 tables is greater than the total number of rows included in the S2 tables, K2 is equal to S1, and the K2 tables in Embodiment 12 are the S1 tables; when the total number of rows included in the S1 tables is less than the total number of rows included in the S2 tables, K2 is equal to S2, and the K2 table are the S2 tables.

In one embodiment, whether the target SRS resource in Embodiment 12 is the first SRS resource or the second SRS resource is related to the first maximum number of layers, the second maximum number of layers, the number of SRS ports of the first SRS resource and the number of SRS ports of the second SRS resource.

In one embodiment, when the target maximum number of layers is equal to the first maximum number of layers, the target SRS resource in Embodiment 12 is the first SRS resource; when the target maximum number of layers is equal to the second maximum number of layers, the target SRS resource in Embodiment 12 is equal to the second SRS resource.

### Embodiment 19

Embodiment 19 illustrates a schematic diagram of relating K2 to a first maximum number of layers and a second maximum number of layers according to one embodiment of the present application; as shown in FIG. 19. In Embodiment 19, K2 is related to the first maximum number of layers and the second maximum number of layers; the first maximum number of layers and the second maximum number of layers are configured separately; the first maximum number of layers is applied to the first SRS resource set in Embodiment 6, and the second maximum number of layers is applied to the second SRS resource set in Embodiment 6; K2 is equal to the smallest value of a target maximum number of layers and a target resource number; the target maximum number of layers is equal to the first maximum number of layers or the second maximum number of layers; when the target maximum number of layers is equal to the first maximum number of layers, the target resource number is equal to the first resource number of Embodiment 6; when the target maximum number of layers is equal to the second maximum number of layers, the target resource number is equal to the second resource number of Embodiment 6; a first higher layer parameter is set to “nonCodebook” and the first higher layer parameter includes “txConfig” in its name.

In one embodiment, whether the target maximum number of layers is the first maximum number of layers or the second maximum number of layers is related to both the first resource number and the second resource number.

In one embodiment, when the first resource number is greater than the second resource number, the target maximum number of layers is equal to the first maximum number of layers; when the first resource number is less than the second resource number, the target maximum number of layers is equal to the second maximum number of layers.

In one embodiment, when the first resource number is equal to the second resource number, the target maximum number of layers is equal to either the first maximum number of layers or the second maximum number of layers.

In one embodiment, when the first resource number is equal to the second resource number, the target maximum number of layers is equal to a greater one of the first maximum number of layers or the second maximum number of layers.

In one embodiment, when the first resource number is equal to the second resource number, the target maximum number of layers is equal to the first maximum number of layers if the SRS-ResourceSetId of the first SRS resource set is less than the SRS-ResourceSetId of the second SRS resource set; the target maximum number of layers is equal to the second maximum number of layers if the SRS-ResourceSetId of the first SRS resource set is greater than the second maximum number of layers.

In one embodiment, a first reference maximum number of layers is equal to a smallest value of the first maximum number of layers and the first resource number, and a second reference maximum number of layers is equal to a smallest value of the second maximum number of layers and the second resource number; when the first reference maximum number of layers is greater than the second reference maximum number of layers, the target maximum number of layers is equal to the first maximum number of layers; when the first reference maximum number of layers is less than the second reference maximum number of layers, the target maximum number of layers is equal to the second maximum number of layers.

In one subembodiment, when the first reference maximum number of layers is equal to the second reference maximum number of layers, the target maximum number of layers is equal to either the first maximum number of layers or the second maximum number of layers.

In one subembodiment, when the first reference maximum number of layers is equal to the second reference maximum number of layers, the target maximum number of layers is equal to a greater one of the first maximum number of layers or the second maximum number of layers.

In one subembodiment, when the first reference maximum number of layers is equal to the second reference maximum number of layers, the target maximum number of layers is equal to a maximum number of layers between the first maximum number of layers and the second maximum number of layers that is applied to one SRS resource set with a smaller SRS-ResourceSetId of the first SRS resource set and the second SRS resource set.

In one embodiment, S3 reference numbers of layers are equal to 1, . . . , S3, respectively, S3 being equal to the first maximum number of layers, and S4 reference numbers of layers are equal to 1 . . . , S4, respectively, S4 being equal to the second maximum number of layers; the S3 reference numbers of layers are used to determine S3 numbers of combinations, respectively, and the S4 reference numbers of layers are used to determine S4 numbers of combinations, respectively; any one of the S3 numbers of combinations is equal to a total number of combinations in which elements whose number is equal to a corresponding reference number of layers are taken from different elements whose number is equal to the first resource number, and any one of the S4 numbers of combinations is equal to a total number of combinations in which elements whose number is equal to a corresponding reference number of layers are taken from different elements whose number is equal to the second resource number; when the sum of the S3 numbers of combinations is greater than the sum of the S4 numbers of combinations, the target maximum number of layers is equal to the first maximum number of layers; and when the sum of the S3 numbers of combinations is less than the sum of the S4 numbers of combinations, the target maximum number of layers is equal to the second maximum number of layers.

In one subembodiment, when the sum of the S3 numbers of combinations is equal to the sum of the S4 numbers of combinations, the target maximum number of layers is equal to either the first maximum number of layers or the second maximum number of layers.

In one subembodiment, when the sum of the S3 numbers of combinations is equal to the sum of the S4 numbers of combinations, the target maximum number of layers is equal to a greater one of the first maximum number of layers or the second maximum number of layers.

In one subembodiment, when the sum of the S3 numbers of combinations is equal to the sum of the S4 numbers of combinations, the target maximum number of layers is equal to a maximum number of layers between the first maximum number of layers and the second maximum number of layers that is applied to one SRS resource set with a smaller SRS-ResourceSetId of the first SRS resource set and the second SRS resource set.

In one embodiment, whether the target resource number in Embodiment 13 is the first resource number or the second resource number is related to the first maximum number of layers, the second maximum number of layers, the first resource number and the second resource number.

In one embodiment, when the target maximum number of layers is equal to the first maximum number of layers, the target resource number in Embodiment 13 is the first resource number; when the target maximum number of layers is equal to the second maximum number of layers, the target resource number in Embodiment 13 is equal to the second resource number.

### Embodiment 20

Embodiment 20 illustrates a structure block diagram of a processing device used in a first node according to one embodiment of the present application, as shown in FIG. 20. In FIG. 20, a processing device 2000 in the first node comprises a first receiver 2001 and a first transmitter 2002.

In Embodiment 20, the first receiver 2001 receives a first signaling, the first signaling indicating scheduling information of a first signal; and the first transmitter 2002 transmits the first signal.

In Embodiment 20, the first signal comprises a first sub-signal and a second sub-signal; the first signaling comprises a first field and a second field; the first field of the first signaling and the second field of the first signaling are respectively used to determine antenna port(s) for transmitting the first sub-signal and antenna port(s) for transmitting the second sub-signal; the first field of the first signaling and the second field of the first signaling are used to determine a precoder for the first sub-signal and a precoder for the second sub-signal, respectively; the first field and the second field each comprise at least one bit, a payload of bit(s) in the second field of the first signaling is related to K1 candidate integers, K1 being a positive integer greater than 1; the K1 candidate integers respectively correspond to K1 numbers of layers; a relationship between the payload of the bit(s) in the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the payload of the bit(s) in the second field of the first signaling is no less than a logarithm of a sum of the K1 candidate integers with base 2; when the time-domain resource occupied by the first sub-signal and the time-domain resource occupied by the second sub-signal are mutually orthogonal, the payload of the bit(s) in the second field of the first signaling is no less than a logarithm of a greatest value of the K1 candidate integers with base 2.

In one embodiment, the K1 numbers of layers respectively correspond to K1 tables; any of the K1 tables includes multiple rows, and at least one row in any of the K1 tables indicates a TPMI; any of the K1 candidate integers is not less than a number of rows included in the corresponding table.

In one embodiment, the K1 numbers of layers respectively correspond to K1 numbers of combinations, the K1 numbers of combinations being positive integers, respectively; any of the K1 candidate integers is not less than the corresponding number of combinations.

In one embodiment, a payload of bit(s) in the first field of the first signaling is related to K2 candidate integers, K2 being a positive integer greater than 1; the K2 candidate integers respectively correspond to K2 numbers of layers; the payload of the bit(s) in the first field of the first signaling is no less than a logarithm of a sum of the K2 candidate integers with base 2.

In one embodiment, K1 is related to at least one of a first maximum number of layers, a second maximum number of layers, and a third maximum number of layers; the first maximum number of layers, the second maximum number of layers, and the third maximum number of layers are positive integers greater than 1, respectively; and at least one of the first maximum number of layers, the second maximum number of layers, or the third maximum number of layers is configurable.

In one embodiment, a value of the K1 is related to whether the time-domain resource occupied by the first sub-signal overlaps with the time-domain resource occupied by the second sub-signal.

In one embodiment, K2 is related to at least one of a first maximum number of layers, a second maximum number of layers, and a third maximum number of layers; the first maximum number of layers, the second maximum number of layers, and the third maximum number of layers are positive integers greater than 1, respectively; and at least one of the first maximum number of layers, the second maximum number of layers, or the third maximum number of layers is configurable.

In one embodiment, the first node is a UE.

In one embodiment, the first node is a relay node.

In one embodiment, the first signaling is a DCI; the first field and the second field each indicate at least one SRI or, alternatively, the first field and the second field each indicate a TPMI; the first field is located before the second field in the first signaling; the K1 candidate integers are K1 positive integers, respectively; and the K1 numbers of layers are K1 positive integers, respectively.

In one embodiment, when the time-domain resource occupied by the first sub-signal and the time-domain resource occupied by the second sub-signal are overlapped, the first sub-signal and the second sub-signal carry different TBs; and when the time-domain resource occupied by the first sub-signal and the time-domain resource occupied by the second sub-signal are mutually orthogonal, the first sub-signal and the second sub-signal carry the same TBs.

In one embodiment, when the time-domain resource occupied by the first sub-signal and the time-domain resource occupied by the second sub-signal are overlapped, the number of layers of the first sub-signal and the number of layers of the second sub-signal are indicated separately; when the time-domain resource occupied by the first sub-signal and the time-domain resource occupied by the second sub-signal are mutually orthogonal, the number of layers of the first sub-signal is equal to the number of layers of the second sub-signal.

In one embodiment, the first receiver 2001 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 2002 comprises at least one of the antenna 452, the transmitter 454, the transmitting processor 468, the multi-antenna transmitting processor 457, the controller/processor 459, the memory 460 or the data source 467 in Embodiment 4.

### Embodiment 21

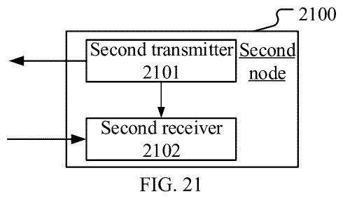

Embodiment 21 illustrates a structure block diagram of a processing device used in a second node according to one embodiment of the present application, as shown in FIG. 21. In FIG. 21, a processing device 2100 in a second node comprises a second transmitter 2101 and a second receiver 2102.

In Embodiment 21, the second transmitter 2101 transmits a first signaling, the first signaling indicating scheduling information of a first signal; and the second receiver 2102 receives the first signal.

In Embodiment 21, the first signal comprises a first sub-signal and a second sub-signal; the first signaling comprises a first field and a second field; the first field of the first signaling and the second field of the first signaling are respectively used to determine antenna port(s) for transmitting the first sub-signal and antenna port(s) for transmitting the second sub-signal; the first field of the first signaling and the second field of the first signaling are used to determine a precoder for the first sub-signal and a precoder for the second sub-signal, respectively; the first field and the second field each comprise at least one bit, a payload of bit(s) in the second field of the first signaling is related to K1 candidate integers, K1 being a positive integer greater than 1; the K1 candidate integers respectively correspond to K1 numbers of layers; a relationship between the payload of the bit(s) in the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the payload of the bit(s) in the second field of the first signaling is no less than a logarithm of a sum of the K1 candidate integers with base 2; when the time-domain resource occupied by the first sub-signal and the time-domain resource occupied by the second sub-signal are mutually orthogonal, the payload of the bit(s) in the second field of the first signaling is no less than a logarithm of a greatest value of the K1 candidate integers with base 2.

In one embodiment, the K1 numbers of layers respectively correspond to K1 tables; any of the K1 tables includes multiple rows, and at least one row in any of the K1 tables indicates a TPMI; any of the K1 candidate integers is not less than a number of rows included in the corresponding table.

In one embodiment, the K1 numbers of layers respectively correspond to K1 numbers of combinations, the K1 numbers of combinations being positive integers, respectively; any of the K1 candidate integers is not less than the corresponding number of combinations.

In one embodiment, a payload of bit(s) in the first field of the first signaling is related to K2 candidate integers, K2 being a positive integer greater than 1; the K2 candidate integers respectively correspond to K2 numbers of layers; the payload of the bit(s) in the first field of the first signaling is no less than a logarithm of a sum of the K2 candidate integers with base 2.

In one embodiment, K1 is related to at least one of a first maximum number of layers, a second maximum number of layers, and a third maximum number of layers; the first maximum number of layers, the second maximum number of layers, and the third maximum number of layers are positive integers greater than 1, respectively; and at least one of the first maximum number of layers, the second maximum number of layers, or the third maximum number of layers is configurable.

In one embodiment, a value of the K1 is related to whether the time-domain resource occupied by the first sub-signal overlaps with the time-domain resource occupied by the second sub-signal.

In one embodiment, K2 is related to at least one of a first maximum number of layers, a second maximum number of layers, and a third maximum number of layers; the first maximum number of layers, the second maximum number of layers, and the third maximum number of layers are positive integers greater than 1, respectively; and at least one of the first maximum number of layers, the second maximum number of layers, or the third maximum number of layers is configurable.

In one embodiment, the second node is a base station.

In one embodiment, the second node is a UE.

In one embodiment, the second node is a relay node.

In one embodiment, the first signaling is a DCI; the first field and the second field each indicate at least one SRI or, alternatively, the first field and the second field each indicate a TPMI; the first field is located before the second field in the first signaling; the K1 candidate integers are K1 positive integers, respectively; and the K1 numbers of layers are K1 positive integers, respectively.

In one embodiment, when the time-domain resource occupied by the first sub-signal and the time-domain resource occupied by the second sub-signal are overlapped, the first sub-signal and the second sub-signal carry different TBs; and when the time-domain resource occupied by the first sub-signal and the time-domain resource occupied by the second sub-signal are mutually orthogonal, the first sub-signal and the second sub-signal carry the same TBs.

In one embodiment, when the time-domain resource occupied by the first sub-signal and the time-domain resource occupied by the second sub-signal are overlapped, the number of layers of the first sub-signal and the number of layers of the second sub-signal are indicated separately; when the time-domain resource occupied by the first sub-signal and the time-domain resource occupied by the second sub-signal are mutually orthogonal, the number of layers of the first sub-signal is equal to the number of layers of the second sub-signal.

In one embodiment, the second transmitter 2101 comprises at least one of the antenna 420, the transmitter 418, the transmitting processor 416, the multi-antenna transmitting processor 471, the controller/processor 475 or the memory 476 in Embodiment 4.

In one embodiment, the second receiver 2102 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, vehicles, automobiles, RSU, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, eNB, gNB, Transmitter Receiver Point (TRP), GNSS, relay satellite, satellite base station, airborne base station, Road Side Unit (RSU), drones, test equipment like transceiving device simulating partial functions of base station or signaling tester.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling being a DCI, the first signaling indicating scheduling information of a first signal; and
a first transmitter, transmitting the first signal, the first signal being transmitted in a PUSCH;
wherein the first signal comprises a first sub-signal and a second sub-signal; the first signaling comprises a first field and a second field; the first field of the first signaling and the second field of the first signaling are respectively used to determine antenna port(s) for transmitting the first sub-signal and antenna port(s) for transmitting the second sub-signal; the first field indicates at least one SRI, and the second field indicates at least one SRI; the first field and the second field each comprise at least one bit, a bitwidth of the second field of the first signaling is related to K1 candidate integers, K1 being a positive integer greater than 1; the K1 candidate integers respectively correspond to K1 numbers of layers; a relationship between the bitwidth of the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the bitwidth of the second field of the first signaling is no less than a logarithm of a sum of the K1 candidate integers with base 2; when the time-domain resource occupied by the first sub-signal and the time-domain resource occupied by the second sub-signal are mutually orthogonal, the bitwidth of the second field of the first signaling is no less than a logarithm of a greatest value of the K1 candidate integers with base 2.

2. The first node according to claim 1, characterized in that the first field is located before the second field in the first signaling; “when the time-domain resource occupied by the first sub-signal overlaps with the time-domain resource occupied by the second sub-signal” means: when a time-frequency resource occupied by the first sub-signal overlaps with a time-frequency resource occupied by the second sub-signal.

3. The first node according to claim 1, characterized in that the K1 numbers of layers respectively correspond to K1 numbers of combinations, the K1 numbers of combinations being positive integers, respectively; the K1 candidate integers are respectively equal to the K1 numbers of combinations; the first signaling indicates a first SRS resource group and a second SRS resource group, the first SRS resource group comprising at least one SRS resource of a first SRS resource set, the second SRS resource group comprising at least one SRS resource of a second SRS resource set; the first sub-signal is transmitted by same antenna port(s) as SRS port(s) of the first SRS resource group, and the second sub-signal is transmitted by same antenna port(s) as SRS port(s) of the second SRS resource group; a number of SRS resources in the first SRS resource set is equal to a first resource number, and a number of SRS resources in the second SRS resource set is equal to a second resource number; a first number of combinations is any one of the K1 numbers of combinations, and a first given number of layers is one of the K1 numbers of layers that corresponds to the first number of combinations; the first number of combinations is represented as
$$( \begin{matrix}p 1 \\ q 1\end{matrix} )$$
or Cₚ₁^{q1}, where the p1 is equal to the second resource number, and the q1 is equal to the first given number of layers.

4. The first node according to claim 1, characterized in that a bitwidth of the first field of the first signaling is related to K2 candidate integers, K2 being a positive integer greater than 1; the K2 candidate integers respectively correspond to K2 numbers of layers; the bitwidth of the first field of the first signaling is no less than a logarithm of a sum of the K2 candidate integers with base 2.

5. The first node according to claim 1, characterized in that the K1 is related to a first maximum number of layers, or, the K1 is related to a second maximum number of layers; the first maximum number of layers and the second maximum number of layers are separately configured.

6. The first node according to claim 1, characterized in that a value of the K1 is related to whether the time-domain resource occupied by the first sub-signal overlaps with the time-domain resource occupied by the second sub-signal.

7. The first node according to claim 4, characterized in that the K2 is related to both a first maximum number of layers and a second maximum number of layers; the first maximum number of layers and the second maximum number of layers are separately configured.

8. A second node for wireless communications, comprising:
a second transmitter, transmitting a first signaling, the first signaling being a DCI, the first signaling indicating scheduling information of a first signal; and
a second receiver, receiving the first signal, the first signal being transmitted in a PUSCH;
wherein the first signal comprises a first sub-signal and a second sub-signal; the first signaling comprises a first field and a second field; the first field of the first signaling and the second field of the first signaling are respectively used to determine antenna port(s) for transmitting the first sub-signal and antenna port(s) for transmitting the second sub-signal; the first field indicates at least one SRI, and the second field indicates at least one SRI; the first field and the second field each comprise at least one bit, a bitwidth of the second field of the first signaling is related to K1 candidate integers, K1 being a positive integer greater than 1; the K1 candidate integers respectively correspond to K1 numbers of layers; a relationship between the bitwidth of the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the bitwidth of the second field of the first signaling is no less than a logarithm of a sum of the K1 candidate integers with base 2; when the time-domain resource occupied by the first sub-signal and the time-domain resource occupied by the second sub-signal are mutually orthogonal, the bitwidth of the second field of the first signaling is no less than a logarithm of a greatest value of the K1 candidate integers with base 2.

9. The second node according to claim 8, characterized in that the first field is located before the second field in the first signaling; “when the time-domain resource occupied by the first sub-signal overlaps with the time-domain resource occupied by the second sub-signal” means: when a time-frequency resource occupied by the first sub-signal overlaps with a time-frequency resource occupied by the second sub-signal; a value of the K1 is related to whether the time-domain resource occupied by the first sub-signal overlaps with the time-domain resource occupied by the second sub-signal.

10. The second node according to claim 8, characterized in that the K1 is related to a first maximum number of layers, or, the K1 is related to a second maximum number of layers; the first maximum number of layers and the second maximum number of layers are separately configured.

11. A method in a first node for wireless communications, comprising:
receiving a first signaling, the first signaling being a DCI, the first signaling indicating scheduling information of a first signal; and
transmitting the first signal, the first signal being transmitted in a PUSCH;
wherein the first signal comprises a first sub-signal and a second sub-signal; the first signaling comprises a first field and a second field; the first field of the first signaling and the second field of the first signaling are respectively used to determine antenna port(s) for transmitting the first sub-signal and antenna port(s) for transmitting the second sub-signal; the first field indicates at least one SRI, and the second field indicates at least one SRI; the first field and the second field each comprise at least one bit, a bitwidth of the second field of the first signaling is related to K1 candidate integers, K1 being a positive integer greater than 1; the K1 candidate integers respectively correspond to K1 numbers of layers; a relationship between the bitwidth of the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the bitwidth of the second field of the first signaling is no less than a logarithm of a sum of the K1 candidate integers with base 2; when the time-domain resource occupied by the first sub-signal and the time-domain resource occupied by the second sub-signal are mutually orthogonal, the bitwidth of the second field of the first signaling is no less than a logarithm of a greatest value of the K1 candidate integers with base 2.

12. The method according to claim 11, characterized in that the first field is located before the second field in the first signaling; “when the time-domain resource occupied by the first sub-signal overlaps with the time-domain resource occupied by the second sub-signal” means: when a time-frequency resource occupied by the first sub-signal overlaps with a time-frequency resource occupied by the second sub-signal.

13. The method according to claim 11, characterized in that the K1 numbers of layers respectively correspond to K1 numbers of combinations, the K1 numbers of combinations being positive integers, respectively; the K1 candidate integers are respectively equal to the K1 numbers of combinations; the first signaling indicates a first SRS resource group and a second SRS resource group, the first SRS resource group comprising at least one SRS resource of a first SRS resource set, the second SRS resource group comprising at least one SRS resource of a second SRS resource set; the first sub-signal is transmitted by same antenna port(s) as SRS port(s) of the first SRS resource group, and the second sub-signal is transmitted by same antenna port(s) as SRS port(s) of the second SRS resource group; a number of SRS resources in the first SRS resource set is equal to a first resource number, and a number of SRS resources in the second SRS resource set is equal to a second resource number; a first number of combinations is any one of the K1 numbers of combinations, and a first given number of layers is one of the K1 numbers of layers that corresponds to the first number of combinations; the first number of combinations is represented as
$$( \begin{matrix}p 1 \\ q 1\end{matrix} )$$
or Cₚ₁^{q1}, where the p1 is equal to the second resource number, and the q1 is equal to the first given number of layers.

14. The method according to claim 11, characterized in that a bitwidth of the first field of the first signaling is related to K2 candidate integers, K2 being a positive integer greater than 1; the K2 candidate integers respectively correspond to K2 numbers of layers; the bitwidth of the first field of the first signaling is no less than a logarithm of a sum of the K2 candidate integers with base 2.

15. The method according to claim 11, characterized in that the K1 is related to a first maximum number of layers, or, the K1 is related to a second maximum number of layers; the first maximum number of layers and the second maximum number of layers are separately configured.

16. The method according to claim 11, characterized in that a value of the K1 is related to whether the time-domain resource occupied by the first sub-signal overlaps with the time-domain resource occupied by the second sub-signal.

17. The method according to claim 14, characterized in that the K2 is related to both a first maximum number of layers and a second maximum number of layers; the first maximum number of layers and the second maximum number of layers are separately configured.

18. A method in a second node for wireless communications, comprising:
transmitting a first signaling, the first signaling being a DCI, the first signaling indicating scheduling information of a first signal; and
receiving the first signal, the first signal being transmitted in a PUSCH;
wherein the first signal comprises a first sub-signal and a second sub-signal; the first signaling comprises a first field and a second field; the first field of the first signaling and the second field of the first signaling are respectively used to determine antenna port(s) for transmitting the first sub-signal and antenna port(s) for transmitting the second sub-signal; the first field indicates at least one SRI, and the second field indicates at least one SRI; the first field and the second field each comprise at least one bit, a bitwidth of the second field of the first signaling is related to K1 candidate integers, K1 being a positive integer greater than 1; the K1 candidate integers respectively correspond to K1 numbers of layers; a relationship between the bitwidth of the second field of the first signaling and the K1 candidate integers is related to whether a time-domain resource occupied by the first sub-signal overlaps with a time-domain resource occupied by the second sub-signal; when the time-domain resource occupied by the first sub-signal overlaps with the time-domain resource occupied by the second sub-signal, the bitwidth of the second field of the first signaling is no less than a logarithm of a sum of the K1 candidate integers with base 2; when the time-domain resource occupied by the first sub-signal and the time-domain resource occupied by the second sub-signal are mutually orthogonal, the bitwidth of the second field of the first signaling is no less than a logarithm of a greatest value of the K1 candidate integers with base 2.

19. The method according to claim 18, characterized in that the first field is located before the second field in the first signaling; “when the time-domain resource occupied by the first sub-signal overlaps with the time-domain resource occupied by the second sub-signal” means: when a time-frequency resource occupied by the first sub-signal overlaps with a time-frequency resource occupied by the second sub-signal; a value of the K1 is related to whether the time-domain resource occupied by the first sub-signal overlaps with the time-domain resource occupied by the second sub-signal.

20. The method according to claim 18, characterized in that the K1 is related to a first maximum number of layers, or, the K1 is related to a second maximum number of layers; the first maximum number of layers and the second maximum number of lavers are separately configured.
